(19) United States
(12) Patent Application Publication
(10) Pub. No.: US 2009/0316884 A1
(43) Pub. Date: Dec. 24, 2009

(54) DATA ENCRYPTION METHOD, ENCRYPTED DATA REPRODUCTION METHOD, ENCRYPTED DATA PRODUCTION DEVICE, ENCRYPTED DATA REPRODUCTION DEVICE, AND ENCRYPTED DATA STRUCTURE

(76) Inventor: Makoto Fujiwara, Kyoto (JP)

Correspondence Address: MCDERMOTT WILL & EMERY LLP, 600 13TH STREET, NW, WASHINGTON, DC, 20005-3096, US

(21) Appl. No.: 11/915,788

(22) PCT Filed: Apr. 6, 2007
(86) PCT No.: PCT/JP2007/057770

§ 371 Date: Nov. 28, 2007

(30) Foreign Application Priority Data
Apr. 7, 2006 (JP) 2006-105973

(51) Int. Cl. H04L 9/28

(52) U.S. Cl. 380/28

(57) ABSTRACT

An encrypted data production device (101) encrypts encryption object data including a plurality of frame data in a cipher block chaining mode using a cipher chaining unit of an arbitrary data length. A frame length/cipher chaining analysis section (114) produces, from AV data management information, additional information headers, each of which corresponds to one of the frame data and includes a frame header for the frame data. An encryption/decryption processing section (109) encrypts the frame data in a cipher block chaining mode to produce a series of a plurality of encrypted data. A header analysis/addition section (118) associates one of the plurality of encrypted data that includes therein a boundary between n^{th} frame data and (n+1)^{th} frame data with the additional information header corresponding to the (n+1)^{th} frame data, and adding the additional information header at a predetermined position.

### TECHNICAL FIELD

The present invention relates to a device for encrypting content data and storing the encrypted data in a target such as a memory card, and a device for decrypting and reproducing encrypted content data stored in the target.

### BACKGROUND ART

In recent years, various formats have been proposed in the art for AV data, such as audio data and video data. Some AV formats use a fixed data length for each frame, and some others use an arbitrary variable length. While a header is placed in each frame in some formats, some other formats such as the MP4 format have headers of different frames placed together.

Moreover, various encryption modes have been proposed in the art. One of the encryption modes is the cipher block chaining mode. In the cipher block chaining mode, encryption is performed by a cipher chaining unit of an arbitrary data length.

Conventional encrypted data production and conventional encrypted data reproduction will be described.

FIG. 22 shows a configuration of a conventional device. The configuration of FIG. 22 includes an encrypted data production/reproduction device 201 for encrypting/decrypting AV data, a first CPU 102 for controlling the system as a whole, a system memory 103 being a DRAM, or the like, and an external bus 104 for exchanging data between these components. The encrypted data production/reproduction device 201 reproduces encrypted AV data stored in an externally-connected target 105 (a storage medium such as an SD card or a memory stick). Or, the encrypted data production/reproduction device 201 encrypts AV data downloaded from outside and stores the encrypted data in the target 105.

The encrypted data production/reproduction device 201 includes a control section 106 (the second CPU) responsible for the internal control, an internal bus 107 used for exchanging data between various sections, a host IF section 108 for controlling the exchange of data with the external bus 104, an encryption/decryption processing section 109 controlled by the control section 106 to encrypt/decrypt confidential information including AV data, an input/output section 110 for inputting/outputting data between the encryption/decryption processing section 109 and the internal bus 107, an internal memory 111 for temporarily storing data processed in the encrypted data production/reproduction device 201, a target IF section 112 for controlling the exchange of data with the target 105, and a decoding/audio processing section 113 for decoding and reproducing decrypted data.

AV data downloaded from a server, or the like, via an external IF, not shown, or AV data obtained by decrypting encrypted data stored in the target 105 is temporarily stored in the system memory 103 (Frame data 1 and Frame data 2 in the figure). Moreover, information defining the data length of the cipher chaining unit to be the unit of encryption in the cipher block chaining mode is set in the system memory 103 as the cipher chaining unit information. Furthermore, header information defining the data length of each frame of AV data and the data length of the entire AV data, information defining the mode of encryption, etc., are set in the system memory 103 as the AV data management information. The data length of the cipher chaining unit and the data length of each frame can be selected arbitrarily.

Under control of the first CPU 102, the encrypted data production/reproduction device 201 encrypts the downloaded AV data according to the cipher chaining unit information and stores the encrypted data in the target 105. Moreover, under control of the first CPU 102, the AV data stored in the target 105 is decrypted according to the cipher chaining unit information and expanded onto the system memory 103 as the data is decrypted. Then, the decrypted AV data is read out from the system memory 103 and decoded and reproduced according to the AV data management information as the data is read out.

Referring to the flow chart of FIG. 23, a conventional method for encrypting the AV data downloaded from outside and storing the encrypted data in the target 105 will be described.

First, in order to prevent the AV data from being stored in an unauthorized target 105, authentication is performed between the encrypted data production/reproduction device 201 to be the host and the target 105 (S11). The authentication process is performed by using an authentication key, which is pre-stored in the encrypted data production/reproduction device 201 and the target 105. After the authentication succeeds, a content key being the key for encrypting AV data is produced. Then, the cipher chaining unit to be the unit of encryption in the cipher block chaining mode is read out from the system memory 103 (S12). Then, frames of AV data (frame data) to be encrypted are input successively (S13). The input frame data are successively encrypted in the cipher block chaining mode until Data END is reached (S14, S15). The encrypted AV data are successively expanded onto the system memory 103. When encryption of one cipher chaining unit is completed, (Yes in S16), the data length of the cipher chaining unit is set in preparation for the next encryption.

The process is repeated until Data END is reached, and when last data is encrypted, the encrypted data, which have been expanded onto the system memory 103, are written at once to the target 105 (S17). The encryption of the downloaded AV data is completed through the process described above. Moreover, the AV data management information and the cipher chaining unit information are similarly stored in the target 105 while being associated with the encrypted AV data.

Referring now to the flow chart of FIG. 24, a conventional method for decrypting and reproducing the encrypted data, which are produced and stored in the target 105 by the method described above, will be described.

First, in order to prevent AV data stored in an unauthorized target 105 from being reproduced, authentication is performed between the encrypted data production/reproduction device 201 to be the host and the target 105 (S21). The authentication process is performed by using an authentication key, which is pre-stored in the encrypted data production/reproduction device 201 and the target 105. After the authentication succeeds, a content key being the key for decrypting AV data is produced. If the authentication is successful, the encrypted AV data is read out from the target 105 (S22). Moreover, the cipher chaining unit information pre-stored in the target 105 while being associated with the encrypted AV data is read out from the target 105, and stored in the system memory 103 (S23).

The encrypted data production/reproduction device 201 performs decryption according to the cipher chaining unit information stored in the system memory 103 (S24, S25). First, in order to decrypt the first encrypted data, the data length of the cipher chaining unit is set. Then, data are successively decrypted, and the decrypted AV data (the chain data in FIG. 24) are successively expanded onto the system memory 103. After decryption of one piece of encrypted data, the data length of the cipher chaining unit is set in preparation for the next decryption. All the encrypted data are decrypted by repeating the above.

Moreover, the AV data management information pre-stored in the target 105 while being associated with the body of the AV data is similarly expanded onto the system memory 103. Therefore, on the system memory 103, the decrypted AV data are expanded in separate portions, i.e., headers for different frame data that are placed together and a plurality of decrypted data. Therefore, they cannot be decoded/reproduced as they are. In view of this, the first CPU 102 is used to convert and re-distribute the header information so that each frame data is stored following the header of that frame data. Since AV data with re-distributed headers is in such a form that it can be decoded/reproduced, it is input from the system memory 103 to the encrypted data production/reproduction device 201 to be decoded/reproduced (S26).

Patent Document 1: Japanese Laid-Open Patent Publication No. 2001-222858

### DISCLOSURE OF THE INVENTION

### Problems to be Solved by the Invention

With the conventional technique described above, the headers for different frame data are stored together in the AV data management information. However, boundaries between frame data cannot be known until the encrypted AV data are all decrypted. Therefore, the header information included in the AV data management information cannot be assigned as headers for corresponding frame data until after the encrypted AV data are all decrypted and expanded onto memory.

Typically, the system memory 103 is often implemented as a DRAM connected to the outside of the chip and has a large capacity. On the other hand, the internal memory 111 in the encrypted data production/reproduction device 101 is often implemented as a small-scale SRAM. Therefore, in order for the encrypted data to be all decrypted and expanded onto memory, the use of the system memory 103 cannot be avoided.

Therefore, with the conventional technique described above, the decoding/reproduction of the encrypted AV data cannot be performed as a closed process within the encrypted data production/reproduction device 101. Where there is an access to the system memory 103, the power consumption increases. Therefore, where the encrypted data production/reproduction device is implemented as a portable terminal (mobile phone, PDA, etc.), for example, there will be a limit with the conventional technique described above on the number of times encrypted AV data can be reproduced without recharging the battery.

The present invention has been made in view of the problem as set forth above, and has an object to realize the reproduction of data encrypted in a cipher block chaining mode without using a system memory, as a closed process within a device only having a little internal memory.

### Means for Solving the Problems

The present invention is directed to a data encryption method for encrypting encryption object data including N (N is an integer being 2 or more) pieces of frame data and management data for managing the N pieces of frame data in a cipher block chaining mode using a cipher chaining unit of an arbitrary data length, the method comprising: a step (a) of producing, from the management data, additional information headers, each of which corresponds to one of the frame data and includes a frame header for the frame data; a step (b) of encrypting the frame data in a cipher block chaining mode to produce a series of a plurality of encrypted data; and a step (c) of associating one of the plurality of encrypted data that includes therein a boundary between n^{th} (n is an integer being 1 or more and less than N) frame data and (n+1)^{th} frame data with the additional information header corresponding to the (n+1)^{th} frame data, and adding the additional information header at a predetermined position in the plurality of encrypted data.

The present invention is also directed to an encrypted data reproduction method for reproducing reproduction object data obtained by encrypting encryption object data including N (N is an integer being 2 or more) pieces of frame data in a cipher block chaining mode using a cipher chaining unit of an arbitrary data length, wherein: the reproduction object data includes: a plurality of encrypted data; and N additional information headers including N frame headers corresponding respectively to the N pieces of frame data, respectively; and the additional information header including an (n+1)^{th} (n is an integer being 1 or more and less than N) frame header is associated with one of the plurality of encrypted data including therein a boundary between n^{th} frame data and (n+1)^{th} frame data and is added at a predetermined position of the plurality of encrypted data, the method comprising: a step (a) of separating the additional information header from the reproduction object data; a step (b) of decrypting the encrypted data read out from the reproduction object data by using information on the data length of the cipher chaining unit; a step (c) of performing a separation/concatenation process on the decrypted data by using information on a frame length stored in a frame header included in the separated additional information header to thereby produce the frame data; and a step (d) of adding the frame header at a beginning of the frame data.

The present invention is also directed to an encrypted data production device for encrypting encryption object data including N (N is an integer being 2 or more) pieces of frame data and management data for managing the N pieces of frame data, in a cipher block chaining mode using a cipher chaining unit of an arbitrary data length, the device comprising: a header production section for producing, from the management data, additional information headers, each of which corresponds to one of the frame data and includes a frame header for the frame data; and a cipher processing section for encrypting the frame data in a cipher block chaining mode to produce a series of a plurality of encrypted data; and a header addition section for associating one of the plurality of encrypted data that includes therein a boundary between n^{th} (n is an integer being 1 or more and less than N) frame data and (n+1)^{th} frame data with the additional information header corresponding to the (n+1)^{th} frame data, and adding the additional information header at a predetermined position in the plurality of encrypted data.

The present invention is also directed to an encrypted data reproduction device for reproducing reproduction object data obtained by encrypting encryption object data including N (N is an integer being 2 or more) pieces of frame data in a cipher block chaining mode using a cipher chaining unit of an arbitrary data length, wherein: the reproduction object data includes: a plurality of encrypted data; and N additional information headers including N frame headers corresponding respectively to the N pieces of frame data, respectively; and the additional information header including an (n+1)^{th} (n is an integer being 1 or more and less than N) frame header is associated with one of the plurality of encrypted data including therein a boundary between n^{th} frame data and (n+1)^{th} frame data and is added at a predetermined position of the plurality of encrypted data, the device comprising: a header separation section for separating the additional information header from the reproduction object data; a decryption processing section for decrypting the encrypted data read out from the reproduction object data by using information on the data length of the cipher chaining unit; a frame data production section for performing a separation/concatenation process on the decrypted data by using information on a frame length stored in a frame header included in the separated additional information header to thereby produce the frame data; and a header addition section for adding the frame header at the beginning of the frame data.

The present invention is also directed to a data structure, in which encryption object data including N (N is an integer being 2 or more) pieces of frame data is encrypted in a cipher block chaining mode using a cipher chaining unit of an arbitrary data length, the data structure comprising: a plurality of encrypted data; and N additional information headers including N frame headers corresponding respectively to the N pieces of frame data, respectively; the additional information header including an (n+1)^{th} (n is an integer being 1 or more and less than N) frame header is associated with one of the plurality of encrypted data including therein a boundary between n^{th} frame data and (n+1)^{th} frame data and is added at a predetermined position of the plurality of encrypted data.

### Effects of the Invention

According to the present invention, frame data with frame headers added at the beginning thereof are produced successively as the encrypted data are decrypted. Therefore, it is possible to once store the produced frame data in an internal memory and then decode and reproduce the frame data as they are within an encrypted data production/reproduction device. Therefore, it is possible to successively reproduce the frame data without decrypting a large amount of encrypted content as with the conventional technique, whereby the process can be performed without using the system memory at all. In addition, the header assignment is performed as a closed process within the encrypted data production/reproduction device, thus presenting no load on a CPU that controls the system. Therefore, it is possible to significantly reduce the power consumption.

### BRIEF DESCRIPTION OF THE DRAWINGS

FIG. 1 shows a general configuration of an information processing system according to embodiments of the present invention.

FIG. 2 shows a concept of encrypted data production according to a first embodiment.

FIG. 3 is a flow chart showing an encrypted data production process according to the first embodiment.

FIG. 4 shows how data are stored in a target.

FIG. 5 generally shows a circuit operation for encrypted data production.

FIG. 6 shows a concept of encrypted data reproduction according to the first embodiment.

FIG. 7 is a flow chart showing an encrypted data reproduction process according to the first embodiment.

FIG. 8 generally shows a circuit operation for encrypted data reproduction.

FIG. 9 shows a concept of encrypted data reproduction according to a variation of the first embodiment.

FIG. 10 shows a concept of encrypted data production according to a second embodiment.

FIG. 11 is a flow chart showing an encrypted data production process according to the second embodiment.

FIG. 12 shows a concept of encrypted data reproduction according to the second embodiment.

FIG. 13 is a flow chart showing an encrypted data reproduction process according to the second embodiment.

FIG. 14 shows a concept of encrypted data production according to a third embodiment.

FIG. 15 is a flow chart showing an encrypted data production process according to the third embodiment.

FIG. 16 shows a concept of encrypted data reproduction according to the third embodiment.

FIG. 17 is a flow chart showing an encrypted data reproduction process according to the third embodiment.

FIG. 18 shows a concept of encrypted data production according to a fourth embodiment.

FIG. 19 is a flow chart showing an encrypted data production process according to the fourth embodiment.

FIG. 20 shows a concept of encrypted data reproduction according to the fourth embodiment.

FIG. 21 is a flow chart showing an encrypted data reproduction process according to the fourth embodiment.

FIG. 22 shows a general configuration of a conventional information processing system.

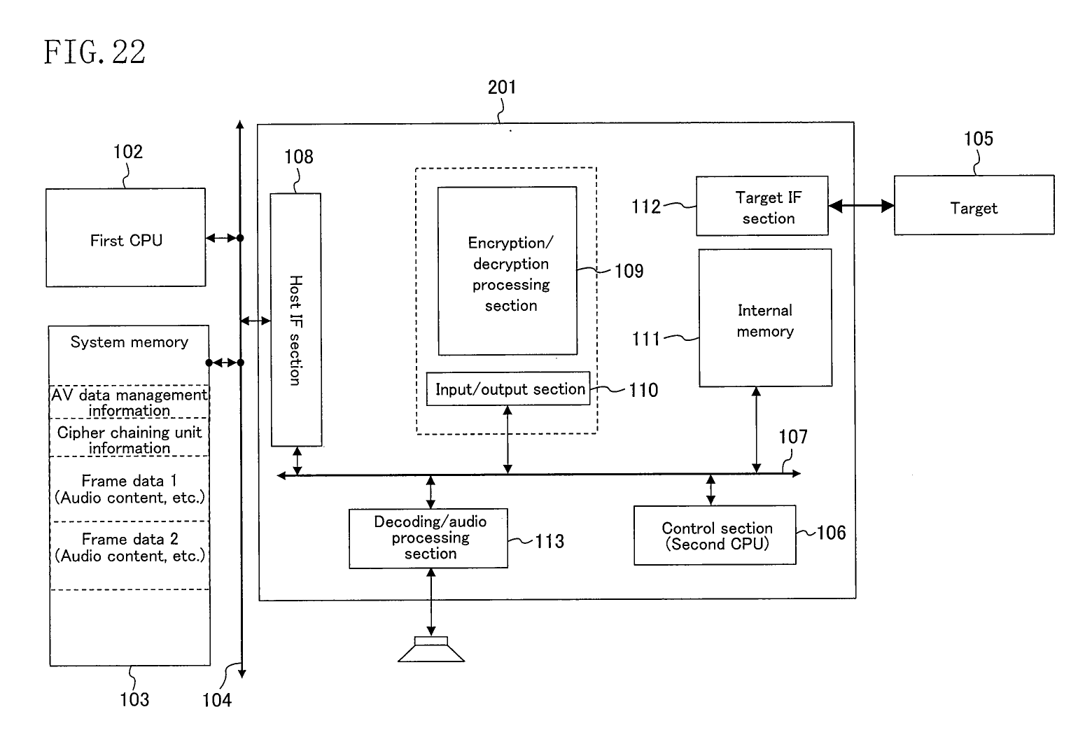

FIG. 23 is a flow chart showing a conventional encrypted data production process.

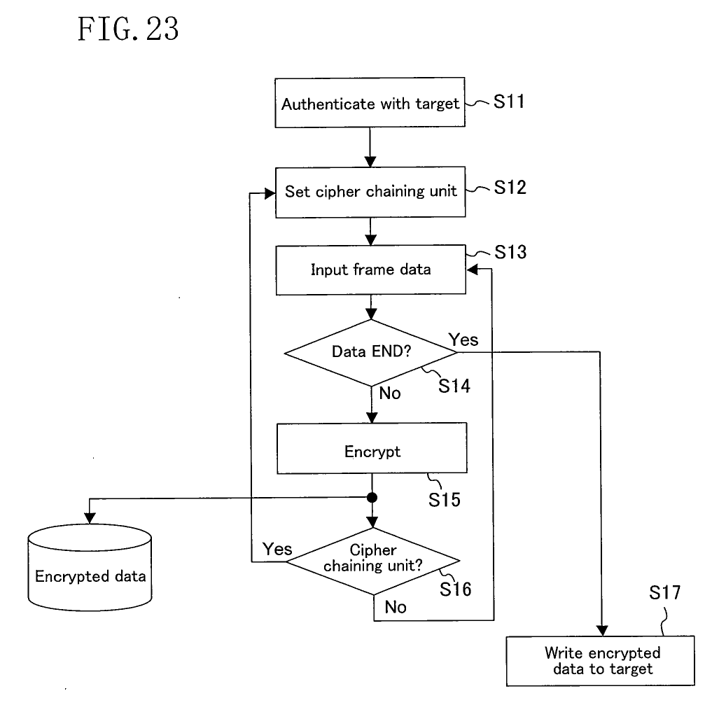

FIG. 24 is a flow chart showing a conventional encrypted data reproduction process.

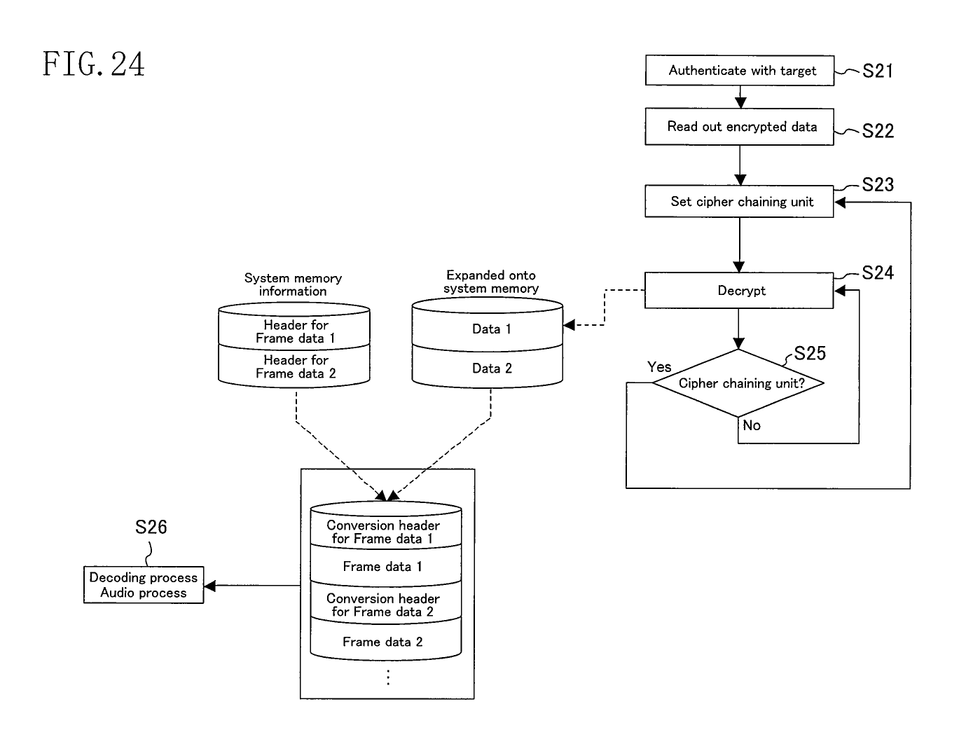

### DESCRIPTION OF REFERENCE NUMERALS

101 Encrypted data production/reproduction device

109 Encryption/decryption processing section

114 Frame length/cipher chaining analysis section

116 Header holding section

117 Data conversion section

118 Header analysis/addition section

### BEST MODE FOR CARRYING OUT THE INVENTION

Embodiments of the present invention will now be described with reference to the drawings. Note that the following embodiments are merely illustrative.

### First Embodiment

<Device Configuration>

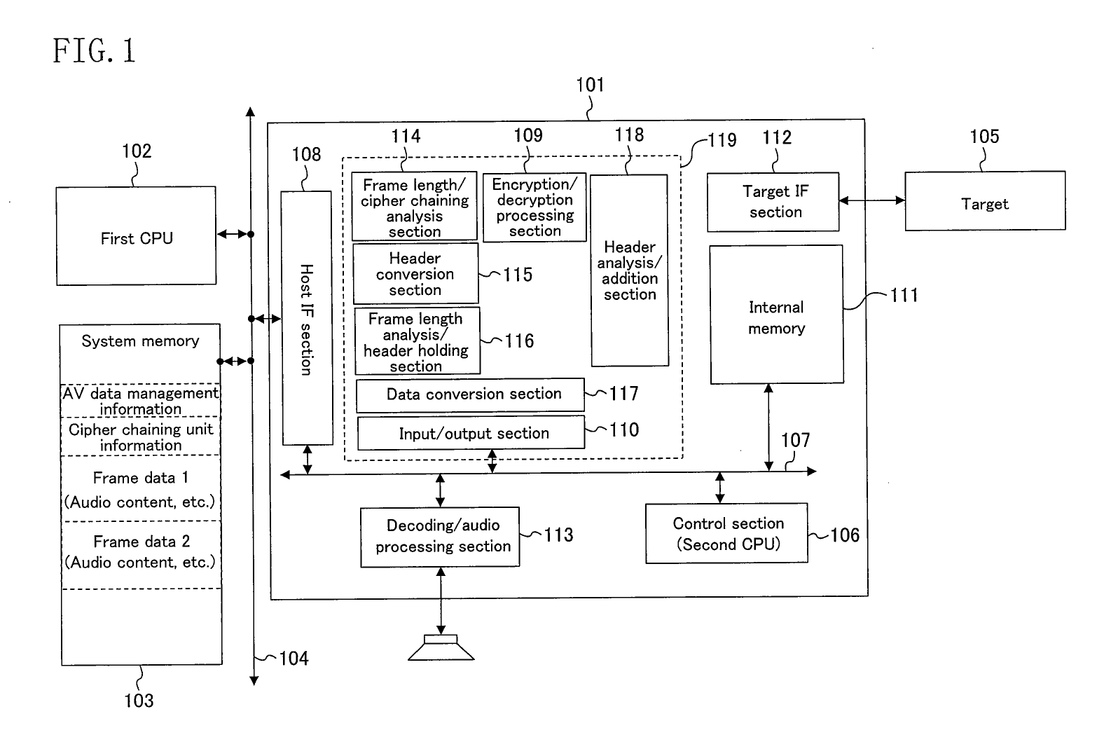

FIG. 1 shows a general configuration of an information processing system including an encrypted data production/reproduction device 101 according to a first embodiment of the present invention, and devices associated therewith. Referring to FIG. 1, the encrypted data production/reproduction device 101 performs encryption and decryption/reproduction of AV data. The first CPU 102 controls the information processing system as a whole, and the system memory 103 is implemented as a DRAM, for example. The encrypted data production/reproduction device 101 is connected to the first CPU 102 and the system memory 103 via the external bus 104, and operates while exchanging data with these components. The encrypted data production/reproduction device 101 is capable of encrypting AV data downloaded from outside and storing the encrypted data in the target 105 as externally-connected storage means. Or, encrypted data production/reproduction device 101 is capable of decrypting and reproducing the encrypted AV data stored in the target 105.

The target 105 is a storage medium such as an SD card or a memory stick. In the present specification, each frame of AV data is referred to as frame data.

The encrypted data production/reproduction device 101 includes the control section 106 (the second CPU) responsible for the internal control of the encrypted data production/reproduction device 101, the internal bus 107 used for exchanging data between various sections in the encrypted data production/reproduction device 101, the host IF section 108 for controlling the exchange of data with the external bus 104, the encryption/decryption processing section 109 controlled by the control section 106 to encrypt/decrypt confidential information including AV data, the input/output section 110 for inputting/outputting data between a confidential information processing section 119 including the encryption/decryption processing section 109 and the internal bus 107, the internal memory 111 being an SRAM, for example, for temporarily storing data processed within the encrypted data production/reproduction device 101, the target IF section 112 for controlling the exchange of data with the target 105, and the decoding/audio processing section 113 for decoding and reproducing decrypted data.

While the system memory 103 does not always need to be a DRAM, the use of a DRAM is optimal as a fast, large-capacity memory. Similarly, the internal memory 111 does not always need to be an SRAM.

In the present embodiment, the confidential information processing section 119 further includes, in addition to the encryption/decryption processing section 109 and the input/output section 110, a frame length/cipher chaining analysis section 114, a header conversion section 115, a frame length analysis/header holding section 116, a data conversion section 117, and a header analysis/addition section 118.

When encrypting the AV data and storing the encrypted data in the target 105, the frame length/cipher chaining analysis section 114 re-distributes pieces of the AV data management information that are stored together in the system memory 103 among headers of different frames, based on which the length of each frame is determined, and the frame length/cipher chaining analysis section 114 determines the length of the cipher chaining unit based on the cipher chaining unit information stored in the system memory 103.

In the decryption process, the header conversion section 115 converts headers embedded in the encrypted content to audio headers.

In the decryption process, the frame length analysis/header holding section 116 analyzes the frame length, and temporarily holds the audio header converted by the header conversion section 115.

When all data needed for the decryption process are completed, the data conversion section 117 rearranges the data so that the audio header is located at the beginning of the corresponding frame data.

The header analysis/addition section 118 adds the header for each frame, which has been extracted and re-distribute by the frame length/cipher chaining analysis section 114, to the beginning of encrypted data where there is a boundary with the preceding frame. Moreover, in the decryption process, header analysis/addition section 118 separates the header from the encrypted content.

Where the encrypted data production/reproduction device 101 of FIG. 1 operates as an encrypted data production device of the present invention, the frame length/cipher chaining analysis section 114 corresponds to the header production section, the encryption/decryption processing section 109 to the cipher processing section, and the header analysis/addition section 118 to the header addition section. Where the encrypted data production/reproduction device 101 of FIG. 1 operates as an encrypted data reproduction device of the present invention, the header analysis/addition section 118 corresponds to the header separation section, the encryption/decryption processing section 109 to the decryption processing section, the data conversion section 117 and the frame length analysis/header holding section 116 to the frame data production section, the header analysis/addition section 118 to the header addition section, and the header conversion section 115 to the header conversion section.

The encrypted data production/reproduction device 101 is typically implemented as an LSI. In such a case, the device may be implemented on a single chip including the first CPU, or they may be implemented on separate chips. With the use of an embedded DRAM process, the device can be made into a single chip including the system memory 103. Even where the DRAM and the first CPU are implemented as a single LSI, one may employ a configuration where the DRAM and the first CPU are not operative, whereby it is possible to reduce the power of the internal DRAM section, thus providing a similar power consumption reducing effect.

It is preferred that the frame length/cipher chaining analysis section 114, the header conversion section 115, the frame length analysis/header holding section 116, the data conversion section 117 and the header analysis/addition section 118, which are added in the present embodiment, are implemented as hardware. Then, it is possible to reduce the power consumption.

An operation of the encrypted data production/reproduction device 101 having such a configuration will now be described in detail.

<Encrypted Data Production>

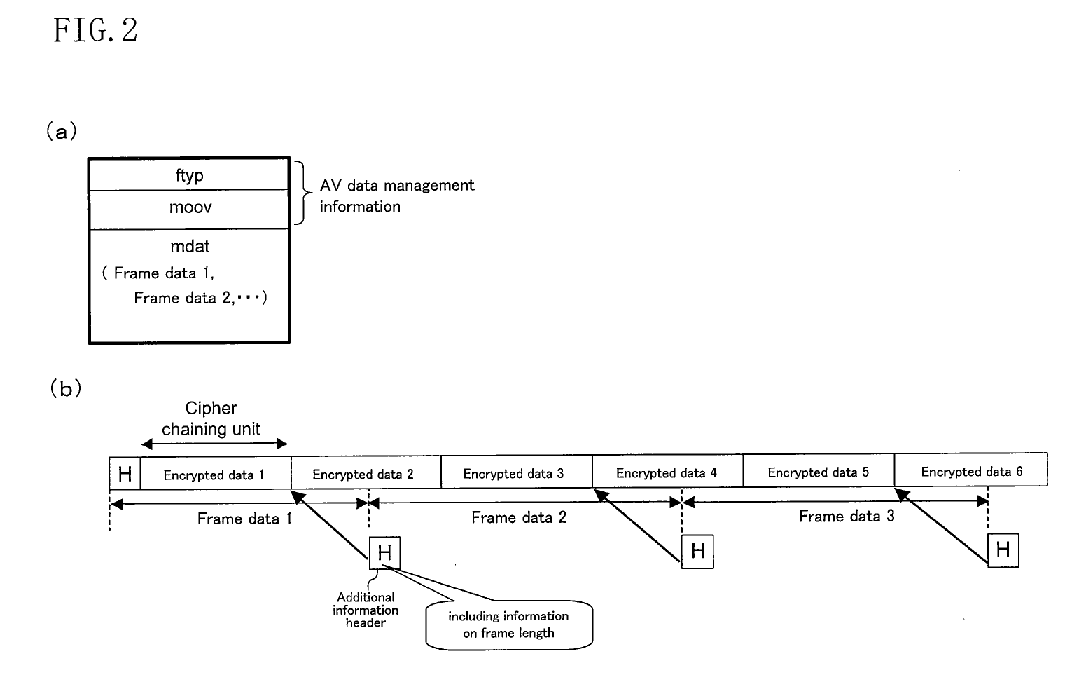

Referring to FIG. 2, a concept will be described for encrypting AV data, which is once stored in the system memory 103, and storing the encrypted data in the target 105 according to the present embodiment.

FIG. 2(a) shows a file structure of the MP4 format, as an exemplary AV data being encryption object data in the present embodiment. Note that MP4 may employ different file structures. In the MP4 file structure of FIG. 2(a), ftyp and moov are the AV data management information as management data. The information ftyp is information indicating the compatibility of the file, and includes, for example, the version information indicating the format in which the AV data is encoded, e.g., AAC, AAC+, AAC++, etc. The information moov includes information such as the frame length of each frame data of the AV data. The frame headers of different frame data are stored together in moov. The body of the AV data is mdat. That is, Frame data 1, Frame data 2, . . . , stored in the system memory 103 of FIG. 1 are placed together in mdat.

In the present embodiment, the frame length/cipher chaining analysis section 114 re-distributes the headers placed together in moov as additional information headers among different frame data after converting the headers as necessary. The additional information header includes a frame header representing information on the frame data. Moreover, the encryption/decryption processing section 109 encrypts the frame data, which are placed together in mdat, in the cipher block chaining mode based on the cipher chaining unit information stored in the system memory 103. Thus, there is produced a series of a plurality of encrypted data, each being a cipher chaining unit of an arbitrary data length.

FIG. 2(b) conceptually shows the method for adding the additional information header in the present embodiment. As shown in FIG. 2(b), the header analysis/addition section 118 adds, to the series of a plurality of encrypted data, additional information headers corresponding to different frame data. Specifically, an additional information header corresponding to the (n+1)^{th} frame data is associated with a piece of encrypted data in which the boundary between the n^{th} frame data and the (n+1)^{th} frame data lies, and the additional information header is added at the beginning of that piece of encrypted data.

Specifically, the additional information header of Frame data 1 is inserted at the beginning of Encrypted data 1 being the very first piece of encrypted data. Since the boundary between Frame data 1 and Frame data 2 lies in Encrypted data 2, the additional information header of Frame data 2 is inserted at the beginning of Encrypted data 2. Since no frame boundary lies in Encrypted data 3, nothing is inserted at the beginning of Encrypted data 3. Since the boundary between Frame data 2 and Frame data 3 lies in Encrypted data 4, the additional information header of Frame data 3 is inserted at the beginning of Encrypted data 4.

Thus, there is produced encrypted content including encrypted data and additional information headers. Herein, the length of the additional information header is a fixed length. The frame header included in an additional information header at least includes information on the data length of the corresponding frame data.

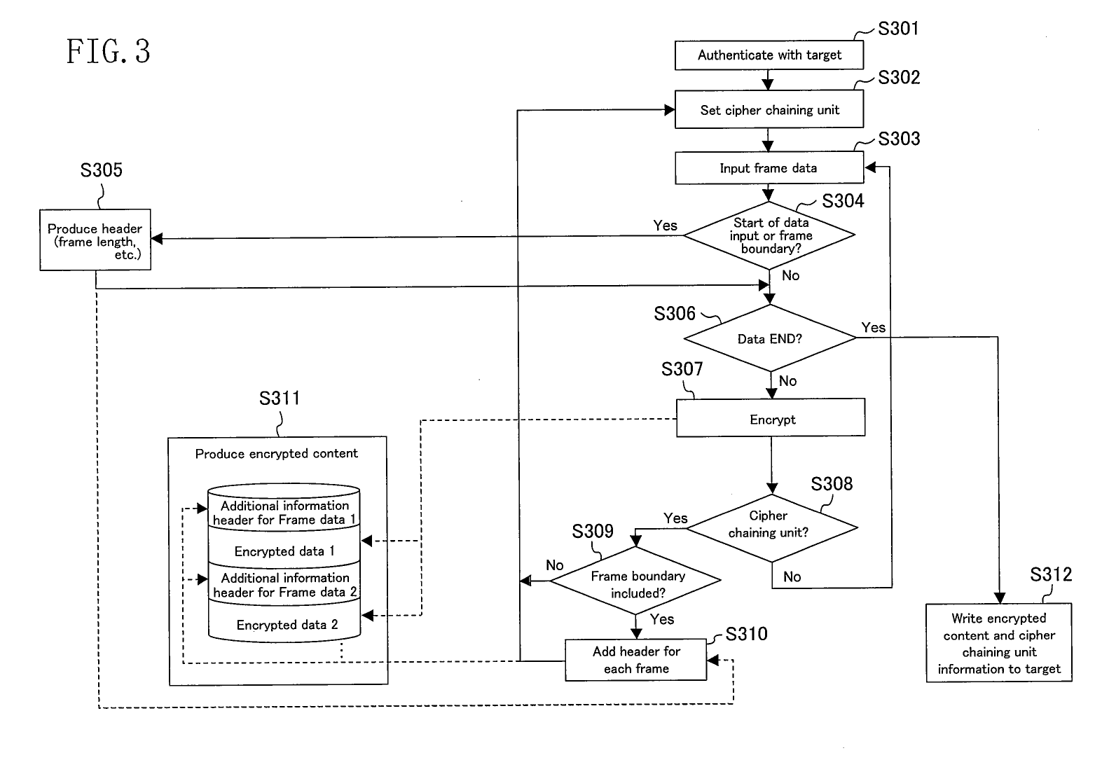

FIG. 3 is a flow chart of the process of encrypting AV data downloaded from outside and storing the encrypted data in the target 105, and the process is for producing encrypted data as shown in FIG. 2(b). In FIG. 3, dotted lines each represent a data process.

First, in order to prevent the AV data from being stored in an unauthorized target 105, authentication is performed between the encrypted data production/reproduction device 101 to be the host and the target 105 (S301). The authentication process is performed by using an authentication key, which is pre-stored in the encrypted data production/reproduction device 101 and the target 105. After the authentication succeeds, a content key being the key for encrypting AV data is produced.

Then, referring to the cipher chaining unit information stored in the system memory 103, the cipher chaining unit to be the unit of encryption in the cipher block chaining mode is set in the encryption/decryption processing section 109 (S302). Then, AV data to be encrypted are input (S303). First, when Frame data 1 being the first data is input, it is determined to be the start of data input (Yes in S304), whereby the frame length/cipher chaining analysis section 114 produces an additional information header for Frame data 1 and stores the additional information header in the internal memory 111 (S305). The additional information header includes the frame length for Frame data 1.

The input AV data are successively encrypted in the cipher block chaining mode and expanded onto the internal memory 111 until the cipher chaining unit ends (S307). When the encryption of the first cipher chaining unit ends (Yes in S308; production of Encrypted data 1 completed), the header analysis/addition section 118 determines whether Encrypted data 1 includes therein a frame boundary (S309). In the example of FIG. 2(b), Encrypted data 1, being the first encrypted data, does not include therein a frame boundary. However, Encrypted data 1 is the first data. Therefore, the header analysis/addition section 118 adds the additional information header for Frame data 1 stored in the internal memory 111 at the beginning of Encrypted data 1 (S310), and then re-expands Encrypted data 1 onto the system memory 103 (S311).

Then, the cipher chaining unit is set again (S302), and the encryption of the second cipher chaining unit is performed successively. Since a frame boundary is included herein, the frame length/cipher chaining analysis section 114 detects a frame boundary (Yes in S304), and the additional information header for Frame data 2 is produced and stored in the internal memory 111. Then, when the encryption of the second cipher chaining unit is all completed (Yes in S308), the header analysis/addition section 118 determines whether Encrypted data 2 includes therein a frame boundary (S309). Since a frame boundary is included, the header analysis/addition section 118 adds the additional information header for Frame data 2 at the beginning of Encrypted data 2 (S310), and re-expands Encrypted data 2 onto the system memory 103 (S311).

Then, the cipher chaining unit is set again, and the encryption of the third cipher chaining unit is performed successively. Since no frame boundary is included herein, after the encryption of the third cipher chaining unit, Encrypted data 3 is expanded onto the system memory 103 as it is. Then, the cipher chaining unit is set again, and the encryption of the fourth cipher chaining unit is performed successively. Since the boundary between Frame data 2 and Frame data 3 is included herein, the frame length/cipher chaining analysis section 114 detects the frame boundary, and the additional information header for Frame data 3 is produced and stored in the internal memory 111. After the encryption of the fourth cipher chaining unit is all completed, the header analysis/addition section 118 adds the additional information header for Frame data 3 at the beginning of Encrypted data, and then Encrypted data 4 is re-expanded onto the system memory 103.

The process is repeated until the end of AV data (S306), when the data, which have been encrypted thus far, are written at once from the system memory 103 to the target 105 as encrypted content (S312). Thus, the entire AV data is encrypted and stored in the target 105 with the additional information header for the (n+1)^{th} frame data added at the beginning of encrypted data including therein the boundary between the n^{th} frame data and the (n+1)^{th} frame data. The cipher chaining unit information stored in the system memory 103 is herein also stored in the target 105 while being associated with encrypted content.

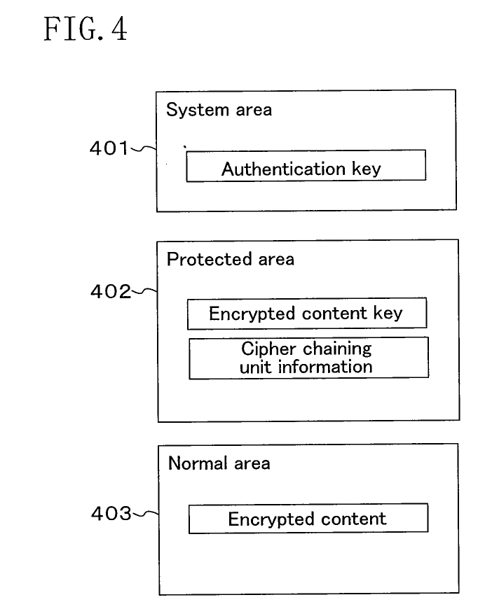

FIG. 4 shows how data are stored in the target 105 after the process of FIG. 3 is completed. The memory area of the target 105 is divided into a system area 401, a protected area 402 and a normal area 403. The system area 401 is an area that is set during manufacture, and cannot be rewritten after the product is manufactured. The system area 401 stores the authentication key, which is necessary for the authentication with the encrypted data production/reproduction device 101. The protected area 402 is an area that can be accessed only when the authentication is successful, and stores the content key being the key for encrypting/decrypting the encrypted content, the cipher chaining unit information, etc. The normal area 403 is an area that can be accessed freely, and stores the encrypted content, which is encrypted by the method described above. Since the protected area 402 needs to be kept about a few % or less of the total storage area, it is in some cases preferred that the cipher chaining unit information is stored in the normal area 403.

According to the flow chart of FIG. 3, the produced encrypted content is once expanded onto the system memory 103, and then written together in the target 105 after the completion of the encryption process. However, according to the present embodiment, it is not necessary to change the order of data at the time when the encryption of one cipher chaining unit is completed. Therefore, the produced encrypted data may be written directly from the internal memory 111 to the target 105 each time the encryption of a cipher chaining unit is completed. In such a case, it is not necessary to re-expand the encrypted data onto the system memory 103, thereby significantly reducing the power consumption required for the production of encrypted content.

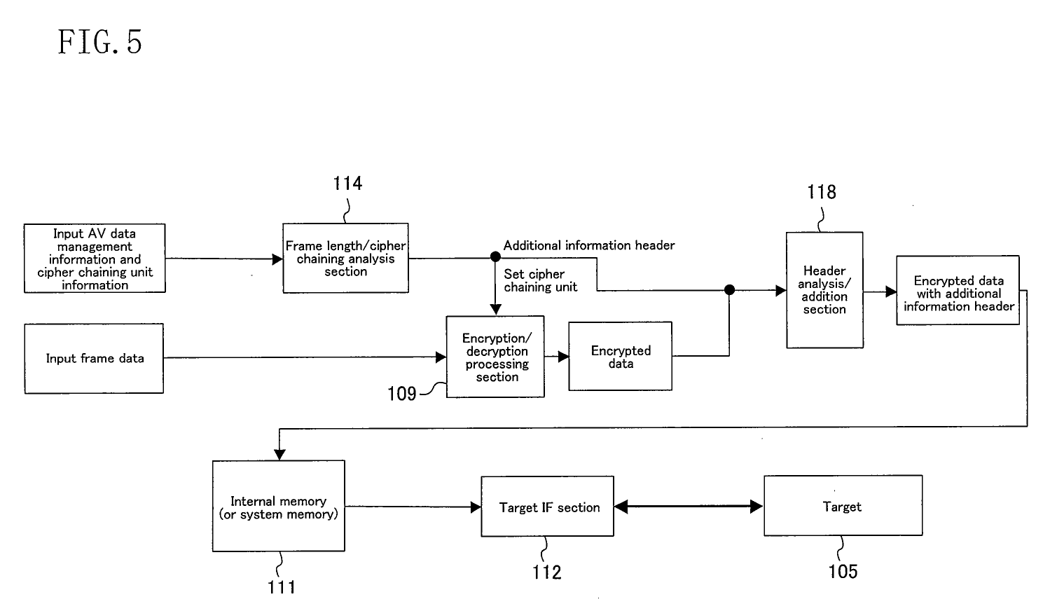

FIG. 5 is a schematic circuit operation diagram showing the operation described above in the form of data flow between circuits. As shown in FIG. 5, the frame length/cipher chaining analysis section 114 reads the AV data management information and the cipher chaining unit information stored in the system memory 103. Then, the frame length/cipher chaining analysis section 114 sets the cipher chaining unit in the encryption/decryption processing section 109, and produces an additional information header including a frame header to output the produced additional information header to the header analysis/addition section 118. The frame data are successively input from the system memory 103 to the encrypted data production/reproduction device 101, and are encrypted in the cipher block chaining mode by means of the encryption/decryption processing section 109. The encrypted data, being the result of encryption, is output to the header analysis/addition section 118. The header analysis/addition section 118 adds an additional information header for each frame at the beginning of appropriate encrypted data including a frame boundary therein, and expands the data onto the system memory 103 as encrypted data with additional information header. When all the encryption is completed, the encrypted data with additional information header is stored, as encrypted content, in the target 105 from the system memory 103 via the target IF section 112.

Where the encrypted data with additional information header is expanded onto the internal memory 111, encrypted data is stored in the target 105 from the internal memory 111 via the target IF section 112 each time the encryption of a cipher chaining unit is completed. Although not shown, the cipher chaining unit information is also stored in the target 105.

The encrypted content produced by the process as described above has a data structure in which an additional information header for the (n+1)^{th} frame data is added at the beginning of encrypted data including therein the boundary between the n^{th} frame data and the (n+1)^{th} frame data. With such a data structure, the decryption and reproduction of encrypted content can be performed without using the system memory 103 as a closed process within the encrypted data production/reproduction device 101, thus significantly reducing the power consumption.

<Decryption/Reproduction of Encrypted Data>

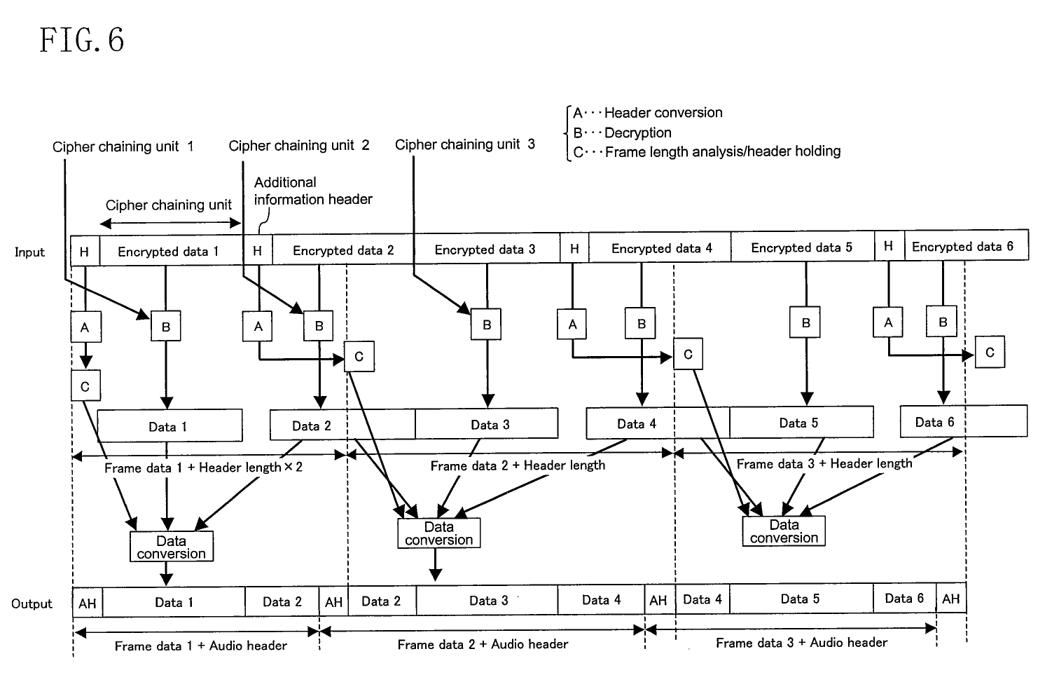

Referring to FIG. 6, the process of decrypting the encrypted content stored in the target 105 according to the present embodiment will be described conceptually. As described above, the encrypted content as reproduction object data has a data structure in which an additional information header for the n+1^{th} frame data is added at the beginning of encrypted data including therein the boundary between the n^{th} frame data and the n+1^{th} frame data.

The control section 106 sets the data length of the cipher chaining unit for each encrypted data in the encryption/decryption processing section 109 based on the cipher chaining unit information stored in the target 105. Based on the information on the data length of the cipher chaining unit and the information on the data length of the frame data included in each additional information header, the header analysis/addition section 118 calculates the position of the additional information header and separates the additional information header from the encrypted content.

The header conversion section 115 converts the additional information header to an audio header (ADTS header: Audio Data Transport Stream) as a reproduction frame header. Herein, the conversion to an audio header represents, for example, a process of converting the header to an AAC header in a case where ftyp in MP4 indicates AAC+ so that the audio data can be reproduced by a device capable of reproducing only in the AAC ADTS format. The converted header is temporarily held at the frame length analysis/header holding section 116. There may be a case where the header conversion is not necessary. In such a case, the frame header included in the additional information header is used as it is.

On the other hand, using the information on the data length of the cipher chaining unit, the encryption/decryption processing section 109 successively decrypts the encrypted data and expands the decrypted data onto the internal memory 111. The frame length analysis/header holding section 116 detects the frame boundary based on the information on the frame length stored in the additional information header, and when the decryption of the encrypted data including a frame boundary therein is completed, the frame length analysis/header holding section 116 outputs the header being held and the decrypted data expanded on the internal memory 111 to the data conversion section 117.

The data conversion section 117 performs a separation/concatenation process on the decrypted data by using the information on the frame length to thereby produce frame data. Then, the converted header is added at the beginning of the frame data, and the data is output to the decoding/audio processing section 113. The output data is data including an audio header for each frame data and being in conformity to the audio format (AAC). Therefore, the output data can be reproduced directly without needing the first CPU 102 or the system memory 103.

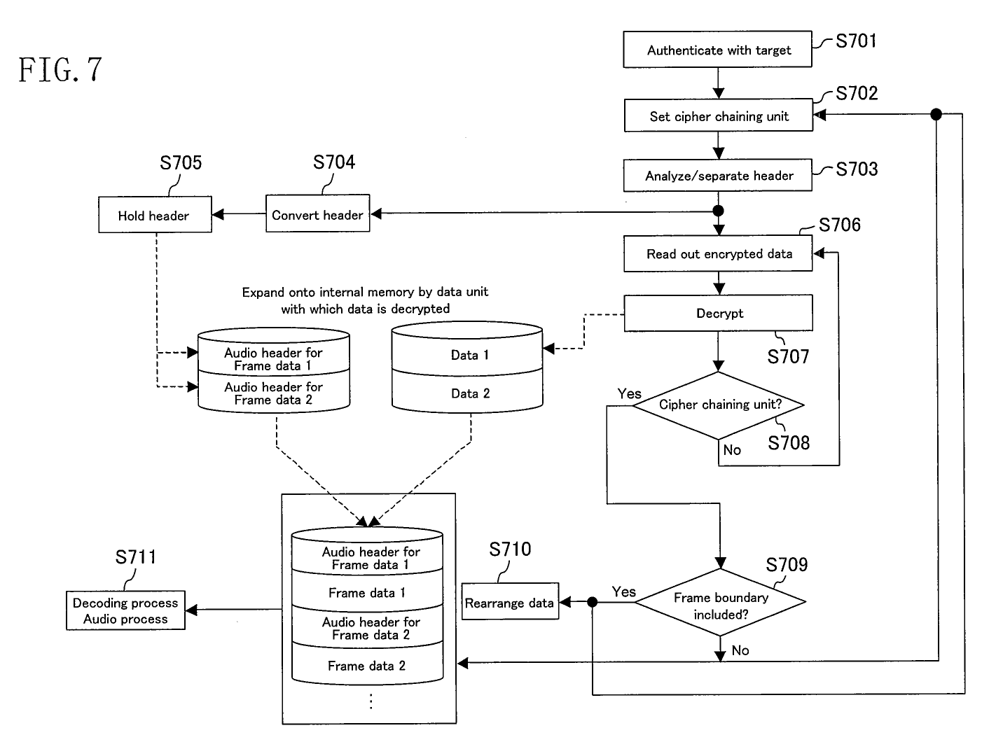

Referring to the flow chart of FIG. 7, the process of decrypting/reproducing the encrypted content as shown in FIG. 6 will be described in detail. In FIG. 7, dotted lines each represent a data process.

First, in order to prevent the reproduction of encrypted content stored in an unauthorized target 105, authentication is performed between the encrypted data production/reproduction device 101 to be the host and the target 105 (S701). The authentication process is performed by using an authentication key, which is pre-stored in the encrypted data production/reproduction device 101 and the target 105. After the authentication succeeds, a content key being the key for decrypting the encrypted content is produced.

Then, referring to the cipher chaining unit information stored in the protected area 402 of the target 105, the control section 106 sets the data length of the cipher chaining unit being the unit of encryption in the cipher block chaining mode in the encryption/decryption processing section 109 (S702). Then, the header analysis/addition section 118 determines whether the additional information header is included at the beginning of the encrypted data, and if the additional information header is included, the header analysis/addition section 118 separates the additional information header (S703). First, it is determined that the additional information header is always included at the beginning of Encrypted data 1, i.e., the first encrypted data. For the second and subsequent encrypted data, the presence/absence of the additional information header is determined based on the data length of the cipher chaining unit and the information on the frame length included in the previously-separated additional information header. The separated additional information header is converted to an audio header by the header conversion section 115 (S704), and is held at the frame length analysis/header holding section 116 (S705).

Moreover, irrespective of whether the additional information header is included, encrypted data are read out from the target 105 to the encrypted data production/reproduction device 101 (S706), and decrypted at the encryption/decryption processing section 109 (S707). The decrypted data are successively expanded onto the internal memory 111.

After the decryption of one piece of encrypted data is completed (Yes in S708), the frame length analysis/header holding section 116 determines whether a frame boundary is included in the encrypted data based on the information of the frame length included in the additional information header (S709). If a frame boundary is included, the data conversion section 117 reads out the audio header being held at the frame length analysis/header holding section 116 and the decrypted data being temporarily stored in the internal memory 111, and rearranges the data so that an audio header is provided at the beginning of new frame data (S710). If no frame boundary is included, the data length of the next cipher chaining unit is set in the encryption/decryption processing section 109 (S702), and the series of operations are repeated.

The frame data produced by the rearrangement are successively input to the decoding/audio processing section 113, where they are decoded and reproduced (S711).

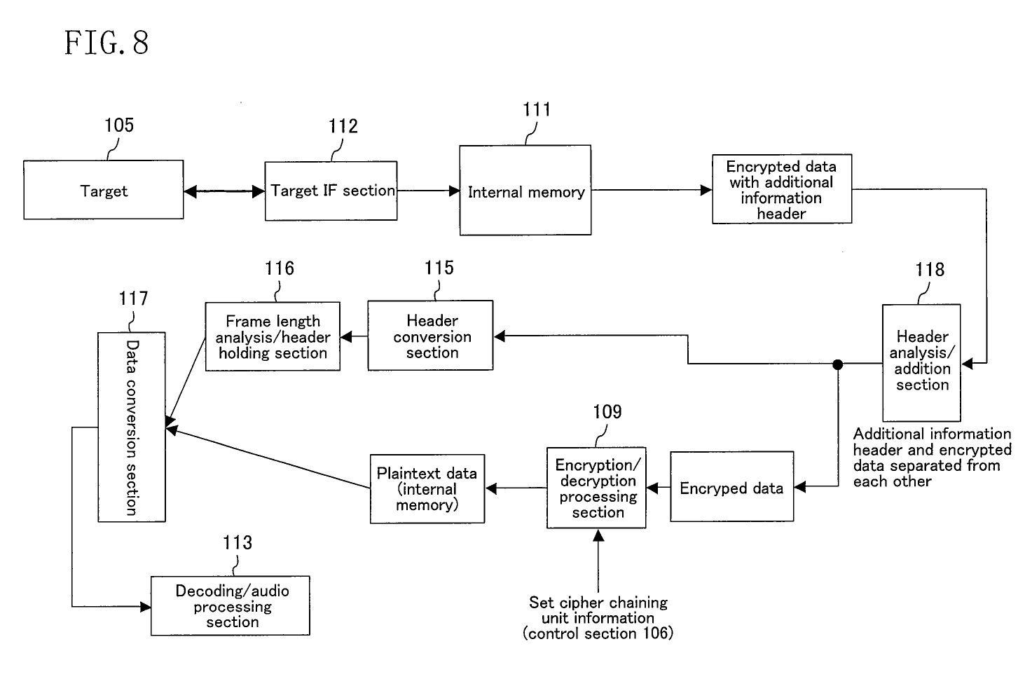

FIG. 8 is a schematic circuit operation diagram showing the operation described above in the form of data flow between circuits. As shown in FIG. 8, the encrypted content stored in the target 105 is input to the internal memory 111 via the target IF section 112 as encrypted data with additional information header. The header analysis/addition section 118 extracts/separates the additional information header from the encrypted data with additional information header read out from the internal memory 111 based on the cipher chaining unit information separately read out from the target 105 and information on the frame length stored in the additional information header. The separated additional information header is output to the header conversion section 115. The header conversion section 115 converts the input additional information header to an audio header, and outputs the converted header to the frame length analysis/header holding section 116. On the other hand, the data length of the cipher chaining unit is set in the encryption/decryption processing section 109 by the control section 106 for each encrypted data. The encryption/decryption processing section 109 decrypts the encrypted data, from which the additional information header has been separated, to obtain plaintext data, which is expanded onto the internal memory 111.

The frame length analysis/header holding section 116 detects encrypted data including a frame boundary therein, and after the data is decrypted, the frame length analysis/header holding section 116 outputs the plaintext data, which has been expanded on the internal memory 111, to the data conversion section 117. Moreover, the audio header, which has been held thereby, is output to the data conversion section 117. The data conversion section 117 rearranges the data so that the corresponding audio header is place at the beginning of frame data, and outputs the rearranged data to the decoding/audio processing section 113. The decoding/audio processing section 113 successively decodes and reproduces the input frame data.

By decrypting the encrypted content by the method described above, it is possible to decrypt a series of encrypted data while transferring data from the internal memory 111 to the decoding/audio processing section 113 in a form where an audio header is provided at the beginning of frame data, and the decoding/audio processing section 113 can directly decode and reproduce the data. Therefore, it is possible to successively reproduce the frame data without decrypting a large amount of encrypted content as with the conventional technique, whereby the process can be performed without using the system memory at all. In addition, the header assignment is performed as a closed process within the encrypted data production/reproduction device 101, thus presenting no load on the first CPU 102. Therefore, it is possible to significantly reduce the power consumption, and it is possible to reproduce, without recharging the battery, a number of encrypted content that is a few times to ten times that with the conventional technique.

According to the flow chart of FIG. 7, the audio header is provided and data is rearranged at the time when one piece of encrypted data is decrypted. Alternatively, the audio header may be inserted upon detection of a frame boundary while successively outputting the decrypted data to the decoding/audio processing section 113. Then, the amount of time over which the audio header is held is reduced (it may become shorter than the holding time for the cipher chaining unit), and the amount of data to be expanded onto the internal memory 111 is also reduced, whereby the circuit scale can be reduced.

### Variation of First Embodiment

In the embodiment described above, cipher chaining unit information representing the data length of the cipher chaining unit is stored in the protected area 402 of the target 105, while being associated with the encrypted content, as separate data from the encrypted content. Alternatively, the cipher chaining unit information may be divided into pieces and included in additional information headers.

Specifically, information on the data length of the cipher chaining unit of the encrypted data may be included in the additional information header. Note however that the additional information header is not provided at the beginning of every encrypted data, but there are some encrypted data with additional information header and some other encrypted data with no additional information header. In view of this, it is assumed in the present variation that each additional information header has information on the data length of the cipher chaining unit for encrypted data present between the current additional information header and the next additional information header.

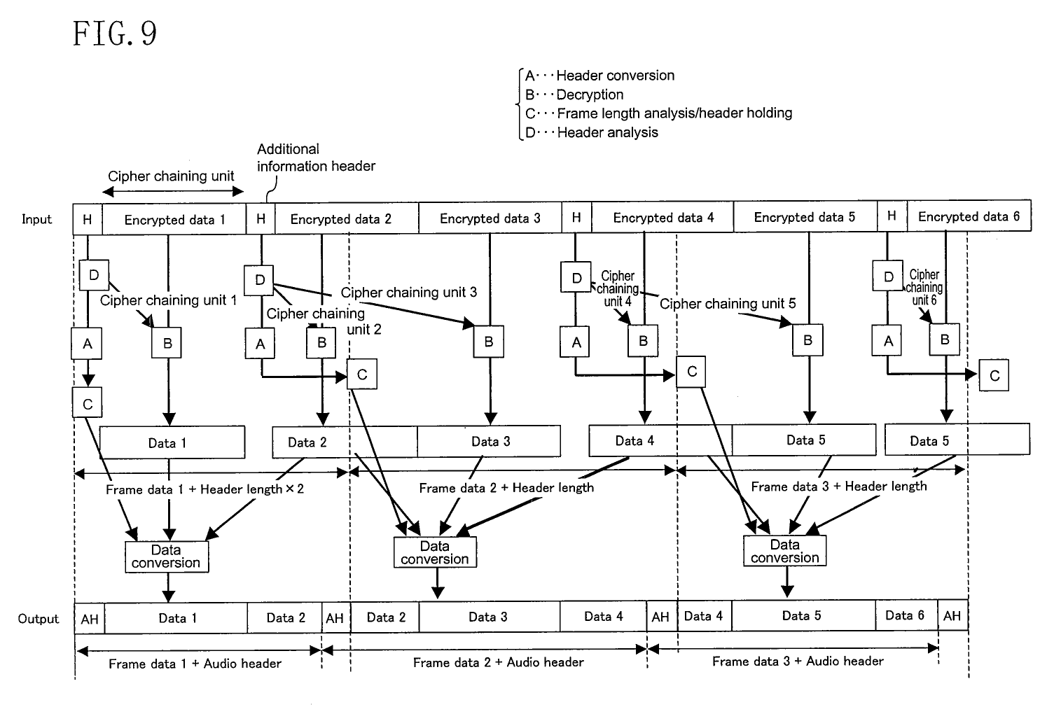

In this case, the decryption of the encrypted content is performed as shown in FIG. 9. Specifically, the data length of the cipher chaining unit for each encrypted data can be obtained by analyzing the additional information header added before the encrypted data.

### Second Embodiment

According to the first embodiment described above, in data encryption, an additional information header corresponding to the (n+1)^{th} frame data is added at the beginning of the encrypted data including therein the boundary between the n^{th} frame data and the (n+1)^{th} frame data. In contrast, according to a second embodiment of the present invention, additional information headers, which are associated with encrypted data including frame data boundaries therein, are added together at the beginning of the series of a plurality of encrypted data. The device configuration of the present embodiment is similar to that of FIG. 1, and will not be further described below.

<Encrypted Data Production>

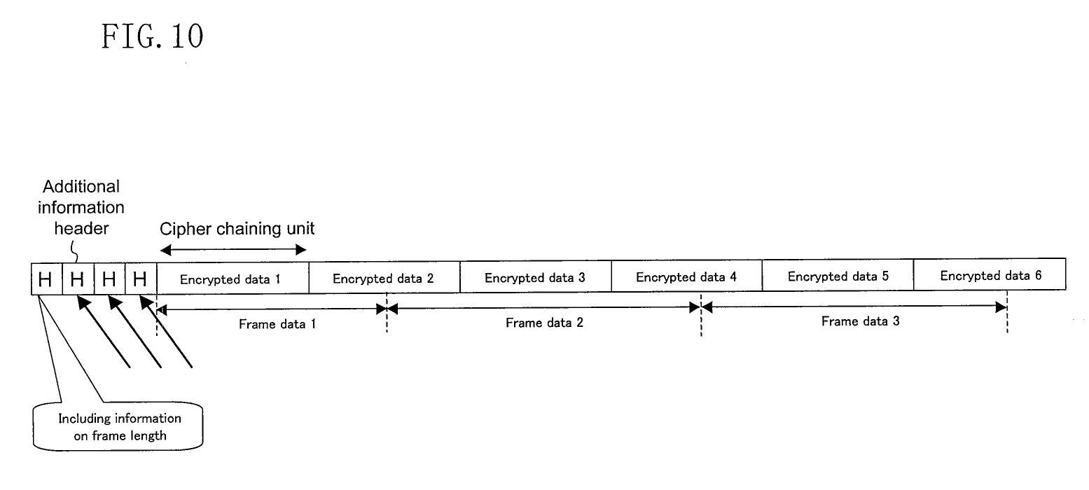

FIG. 10 shows a concept of encrypted data production according to the present embodiment, conceptually showing a method for adding an additional information header. As shown in FIG. 10, according to the present embodiment, additional information headers each for one frame data are placed together at the beginning of the series of encrypted data. The additional information headers and the corresponding frame data are associated with each other.

Furthermore, the relationship between the additional information header and the encrypted data is similar to that of the first embodiment, wherein an additional information header corresponding to the (n+1)^{th} frame data is associated with the encrypted data including therein the boundary between the n^{th} frame data and the (n+1)^{th} frame data. Specifically, the first additional information header corresponds to Encrypted data 1. The second additional information header corresponds to Encrypted data 2 since the boundary between Frame data 1 and Frame data 2 lies in Encrypted data 2. Since Encrypted data 3 includes no frame boundary therein, and there is no additional information header corresponding to Encrypted data 3. Since the boundary between Frame data 2 and Frame data 3 lies in Encrypted data 4, the third additional information header corresponds to Encrypted data 4.

As in the first embodiment, an additional information header includes a frame header including information on the data length of the corresponding frame data. In addition, an additional information header of the present embodiment includes an offset. Herein, an offset is information that indicates which encrypted data the additional information header corresponds to. Specifically, the offset is, for example, information that represents the number of the corresponding encrypted data, counting from the first data, or information that represents the bit length from the beginning to the position of the corresponding encrypted data. Based on the offset, it is possible to know which encrypted data the additional information header is associated.

In the present embodiment, the additional information headers do not always need to be placed at the beginning of the series of encrypted data, but may be placed in other places as long as they are placed together. They may be placed in a region different from that of the encrypted data.

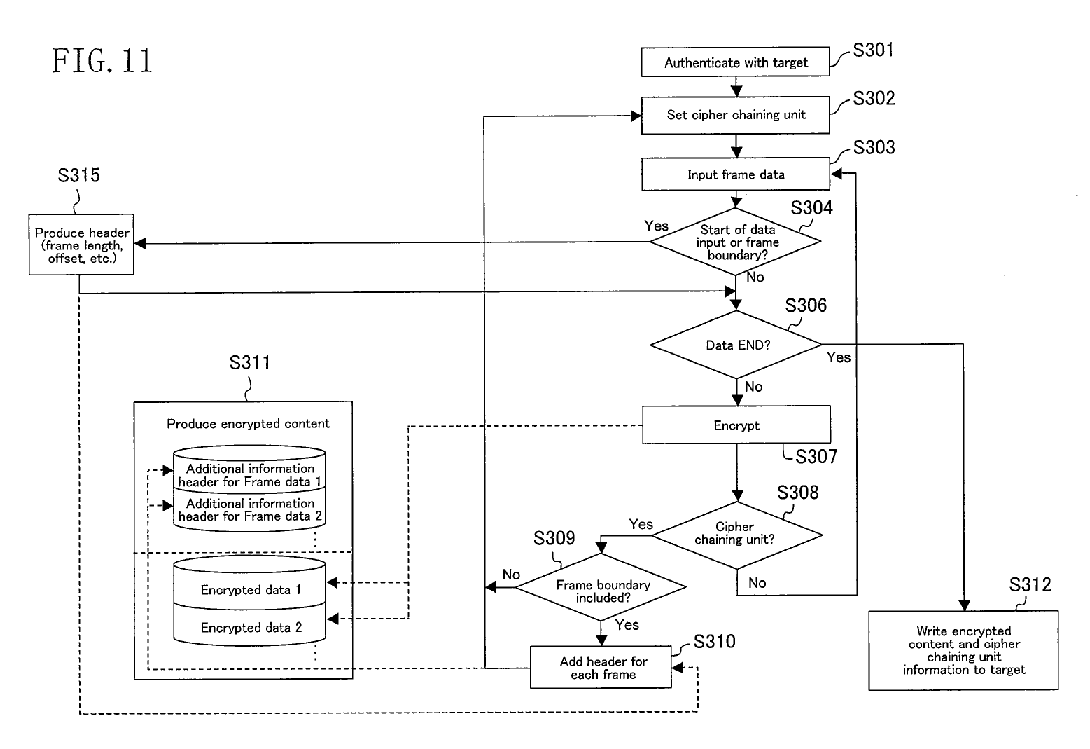

FIG. 11 is a flow chart showing a process of encrypting the AV data downloaded from outside and storing the encrypted data in the target 105, and is for producing encrypted content as shown in FIG. 10. In FIG. 11, dotted lines each represent a data process.

The flow chart of FIG. 11 is substantially similar to FIG. 3, and like steps to those of FIG. 3 are denoted by like reference numerals and will not be further described below. What is different from FIG. 3 is the header production step (S315). In step S315, the frame length/cipher chaining analysis section 114 produces an additional information header so that an offset is included in addition to the frame length, etc. Then, in step S310, the additional information headers are placed together at the beginning of the encrypted data (S311). In this case, it is preferred that a memory area for storing the additional information headers is provided in advance when the encrypted content is produced.

<Decryption/Reproduction of Encrypted Data>

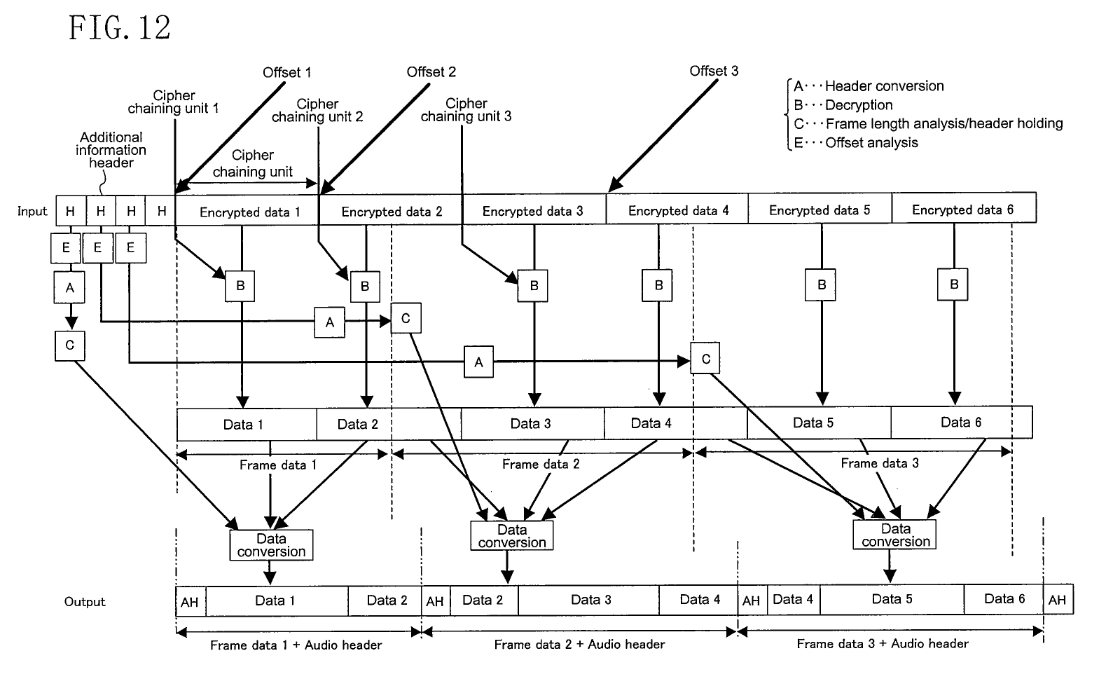

Referring to FIG. 12, the process for decrypting the encrypted data according to the present embodiment will be described conceptually. As described above, the encrypted content as reproduction object data has a data structure in which additional information headers, which are associated with encrypted data including frame data boundaries therein, are added together at the beginning of the series of encrypted data.

The process of FIG. 12 is substantially similar to that of FIG. 6 in the first embodiment. What is different is that the header analysis/addition section 118 determines the encrypted data to which each additional information header corresponds by analyzing the offset of the additional information header.

In the present embodiment, an additional information header and the corresponding encrypted data are not placed in contiguous address spaces. Therefore, when the analysis of one additional information header is completed, the read address at which data is to be read out from the target 105 is set to be the beginning of the encrypted data to be processed, based on the offset. For example, the position of Encrypted data 1 is set as Offset 1 in the first additional information header, and the position of Encrypted data 2 is set as Offset 2 in the second additional information header, and the position of Encrypted data 4 is set as Offset 3 in the third additional information header. After the analysis of the first additional information header is completed, the read address is changed to the beginning of Encrypted data 1, and decryption is performed. After the analysis of the second additional information header is completed, the read address is changed to the beginning of Encrypted data 2, and decryption is performed. Then, continuously, the analysis of the third additional information header is performed after the decryption of Encrypted data 3 is completed. After the analysis of the third additional information header is completed, the read address is changed to the beginning of Encrypted data 4, and decryption is performed. The specific flow chart will be described later.

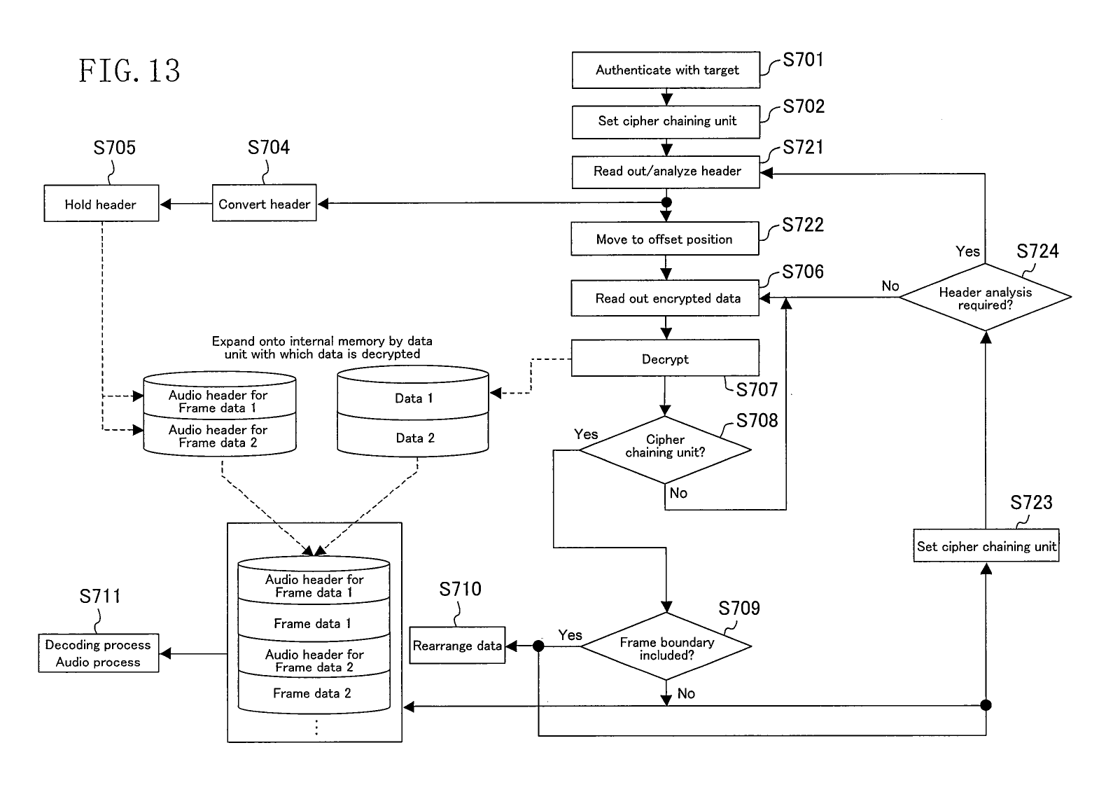

Referring to the flow chart of FIG. 13, the process of decrypting/reproducing the encrypted content as shown in FIG. 12 will be described in detail. In FIG. 13, dotted lines each represent a data process.

First, in order to prevent the reproduction of encrypted content stored in an unauthorized target 105, authentication is performed between the encrypted data production/reproduction device 101 to be the host and the target 105 (S701). The authentication process is performed by using an authentication key, which is pre-stored in the encrypted data production/reproduction device 101 and the target 105. After the authentication succeeds, a content key being the key for decrypting the encrypted content is produced.

Then, referring to the cipher chaining unit information stored in the protected area 402 of the target 105, the control section 106 sets the data length of the cipher chaining unit of Encrypted data 1, i.e., the first encrypted data, in the encryption/decryption processing section 109 (S702). Since the first additional information header corresponds to Encrypted data 1, the header analysis/addition section changes the read address at which data is to be read out from the target 105 to the first additional information header, and reads out and analyzes data (S721). Whether or not the second and subsequent additional information headers are included is determined based on the data length of the cipher chaining unit and information on the frame length included in the previously-separated additional information header. The separated additional information header is converted to an audio header by the header conversion section 115 (S704), and is held at the frame length analysis/header holding section 116 (S705).

Moreover, in the present embodiment, the additional information header includes, in the form of an offset, the information on the position of the corresponding encrypted data. Therefore, referring to the offset, the read address at which data is to be read out from the target 105 is changed to the beginning of the encrypted data to be processed (S722), and the encrypted data is read out from the target 105 to the encrypted data production/reproduction device 101 (S706). The read out encrypted data are decrypted by the encryption/decryption processing section 109 (S707). The decrypted data are successively expanded onto the internal memory 111.

After the decryption of one piece of encrypted data is completed (Yes in S708), the frame length analysis/header holding section 116 determines whether a frame boundary is included in the encrypted data based on the information of the frame length included in the additional information header (S709). If a frame boundary is included, the data conversion section 117 reads out the audio header being held at the frame length analysis/header holding section 116 and the decrypted data being temporarily stored in the internal memory 111, and rearranges the data so that an audio header is provided at the beginning of new frame data (S711).

On the other hand, where no frame boundary is included, the data length of the next cipher chaining unit is set in the encryption/decryption processing section 109 (S723). Then, it is determined whether it is necessary to analyze the additional information header (i.e., whether the next encrypted data includes an additional information header) based on the frame length information included in the previously-analyzed additional information header, the data length of the encrypted data, which have been decrypted, and information on the data length of the cipher chaining unit to be decrypted next (S724). Where it is not necessary to analyze the additional information header, the encrypted data is read out from the target 105 and decrypted. Where it is necessary to analyze the additional information header, the read address at which data is to be read out from the target 105 is changed to the position of the next additional information header, and the series of operations are repeated, starting from the operation of reading out and analyzing the header.

The frame data produced by the rearrangement are successively input to the decoding/audio processing section 113, where they are decoded and reproduced (S711).

The diagram generally showing the circuit operation of the present embodiment is similar to that of FIG. 8 in the first embodiment. Note however that some of the processes performed by the various components are modified from those of the first embodiment, as shown in the flow chart of FIG. 13.

### Third Embodiment

According to the first embodiment described above, in data encryption, an additional information header for the (n+1)^{th} frame data is associated with encrypted data including therein the boundary between the n^{th} frame data and the (n+1)^{th} frame data, and the additional information header is added at the beginning of the encrypted data. Thus, there is no header at the beginning of encrypted data including no frame data boundary therein.

In contrast, according to a third embodiment of the present invention, a fixed-length header is provided at the beginning of every encrypted data, irrespective of the presence of a frame data boundary. Specifically, a dummy header including no frame header is added at the beginning of encrypted data including no frame data boundary therein.

The additional information header and the dummy header each include a flag indicating whether the header is a true header of frame data. Specifically, the flag indicates whether the header includes a frame header. Herein, the flag being 1 indicates that the header is an additional information header including a frame header, and the flag being 0 indicates that the header is a dummy header including no frame header.

Furthermore, each header stores information on the data length of the cipher chaining unit of the corresponding encrypted data. Specifically, even a dummy header whose flag is 0 has information on the data length of the cipher chaining unit. Therefore, the process is simpler than where each additional information header includes information on the data length of the cipher chaining unit for one or more encrypted data, as in the variation of the first embodiment. Moreover, the control section 106 does not need to re-distribute headers, thus simplifying the process. The device configuration of the present embodiment is similar to that of FIG. 1, and will not be further described below.

<Encrypted Data Production>

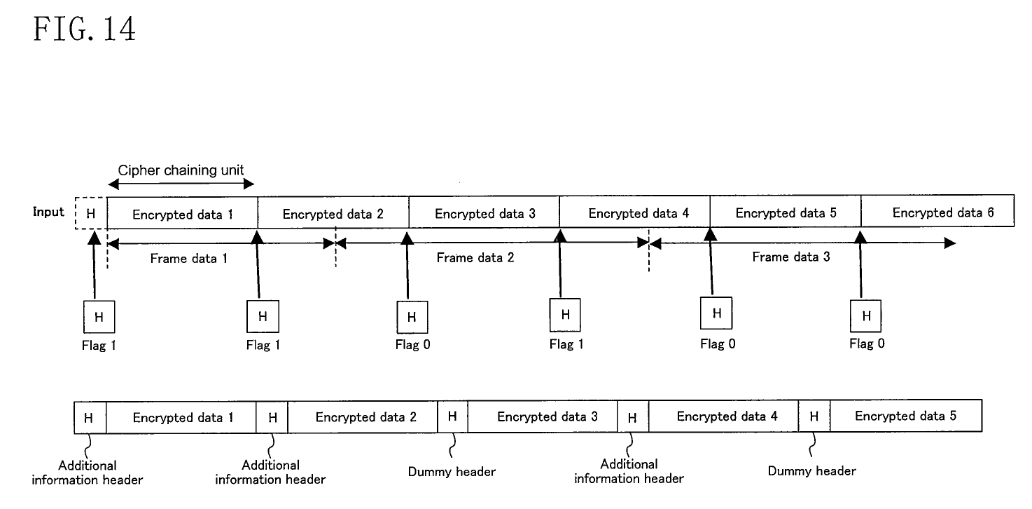

FIG. 14 shows a concept of encrypted data production according to the present embodiment, conceptually showing a method for adding an additional information header. Herein, it is assumed that a header format common to all encrypted data is provided in advance. The header format is assigned a frame header field for storing a frame header, a cipher chaining unit field for storing information on the data length of the cipher chaining unit, and a flag. The flag is initially 0.

The frame length/cipher chaining analysis section 114 re-distributes the headers placed together in moov as frame headers among different frames. Then, a frame header corresponding to the (n+1)^{th} frame data is stored in the frame header field of the header, which is added at the beginning of encrypted data including therein the boundary between the n^{th} frame data and the (n+1)^{th} frame data, and the flag of the header is set to 1. Moreover, the cipher chaining unit field of each header is rewritten based on the cipher chaining unit information stored in the system memory 103.

Specifically, as shown in FIG. 14, the frame header of Frame data 1 is inserted in the header (additional information header) placed at the beginning of Encrypted data 1, and the flag of the header is set to 1. Therefore, in the additional information header, the information on the data length of the cipher chaining unit and the information on the frame length of Frame data 1 are both effective. Since the boundary between Frame data 1 and Frame data 2 lies in Encrypted data 2, the header (additional information header) placed at the beginning of the encrypted data is inserted in the frame header of Frame data 2, and the flag of the header is set to 1. Therefore, also in the additional information header, the information on the data length of the cipher chaining unit and the information on the frame length of Frame data 2 are both effective. Since no frame boundary lies in Encrypted data 3, the header (dummy header) placed at the beginning of the encrypted data has a flag being 0, and only the information on the data length of the cipher chaining unit is effective.

Herein, it is assumed that the length of each header is a fixed length. Moreover, the frame header includes not only information on the frame length but also information on the audio file format, etc.

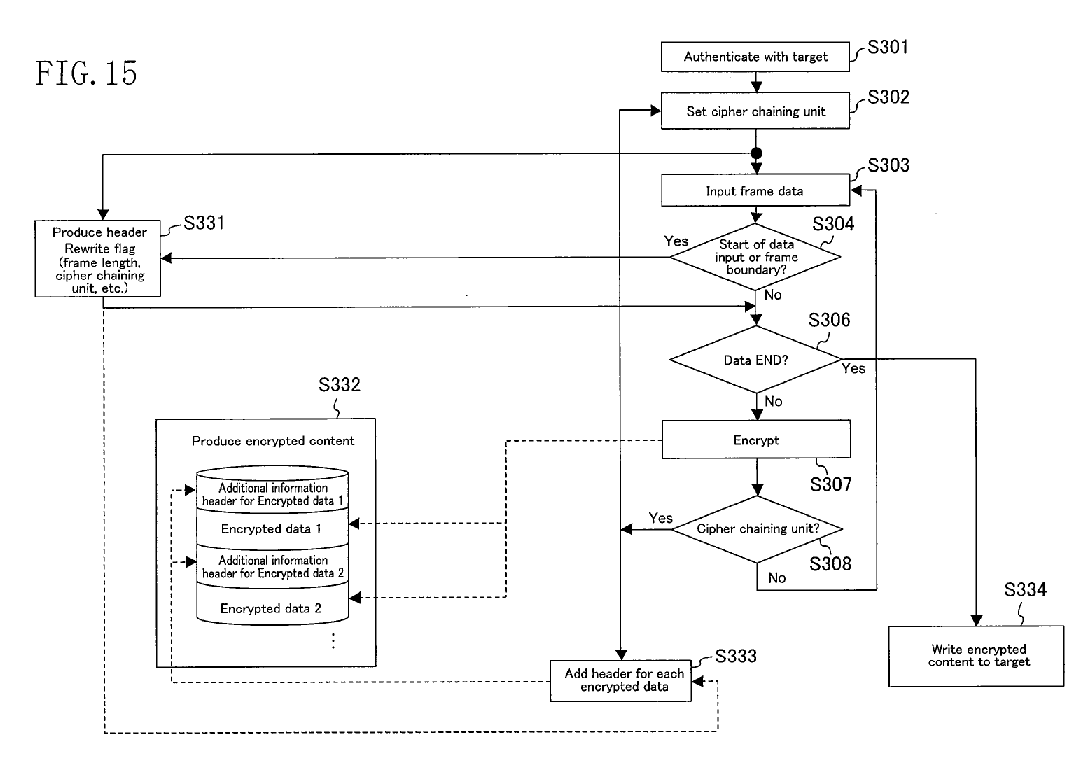

FIG. 15 is a flow chart of the process of encrypting AV data downloaded from outside and storing the encrypted data in the target 105, and the process is for producing encrypted data as shown in FIG. 14. In FIG. 15, dotted lines each represent a data process. Like steps to those of FIG. 3 in the first embodiment are denoted by like reference numerals and will not be further described below.

Each time the cipher chaining unit is set in the encryption/decryption processing section 109 (S302), the frame length/cipher chaining analysis section 114 rewrites the cipher chaining unit field in the common header format prepared in advance to the data length of the cipher chaining unit, which has been set. Moreover, at the start of data input (Yes in S304), the flag of the header for Encrypted data 1, i.e., the first encrypted data, is rewritten to 1, and the frame header field of the header is rewritten to the frame header of Frame data 1. Moreover, when the boundary between the n^{th} frame data and the (n+1)^{th} frame data is detected (Yes in S304), the flag of the header for the detected encrypted data is rewritten to 1, and the frame header field of the header is rewritten to the frame header of the (n+1)^{th} frame data.

When encryption of one cipher chaining unit is completed (Yes in S308), the header analysis/addition section 118 reads out the header produced in step S331 from the frame length/cipher chaining analysis section 114, and adds the header at the beginning of the encrypted data.

The encrypted data is expanded onto the system memory 103 with the header added at the beginning of the encrypted data. As a result, a header is added at the beginning of every encrypted data, but only headers placed at the beginning of encrypted data including frame boundaries therein, i.e., only additional information headers, include frame headers, whereas other headers, i.e., dummy headers, include information on the data length of the cipher chaining unit but do not include frame headers. Of course, a dummy header may include information other than the data length of the cipher chaining unit.

When the encryption is completed for all of the AV content, and encrypted content for all of the AV content is produced, the encrypted content is read out from the system memory 103 and written to the target 105. Note however that the cipher chaining unit information stored in the system memory 103 are embedded in the headers provided at the beginning of the encrypted data, and therefore are not written to the target 105.

In the present embodiment, each time the encryption of the cipher chaining unit is completed, a header is placed at the beginning of the encrypted data. Therefore, it is no always necessary to expand the encrypted data onto the system memory 103, and each encrypted data may be separately written from the internal memory 111 to the target 105. Then, it is not necessary to re-expand the encrypted data onto the system memory 103, thus significantly reducing the power consumption required for the production of encrypted content.

The encrypted content produced by the process as described above has a data structure in which an additional information header including a frame header for the (n+l )^{th} frame data is added at the beginning of each encrypted data including therein the boundary between the n^{th} frame data and the (n+1)^{th} frame data while a dummy header including no frame header is added at the beginning of each encrypted data including no frame data boundary therein. With such a data structure, the decryption and reproduction of encrypted content can be performed without using the system memory 103 as a closed process within the encrypted data production/reproduction device 101, thus significantly reducing the power consumption.

<Decryption/Reproduction of Encrypted Data>

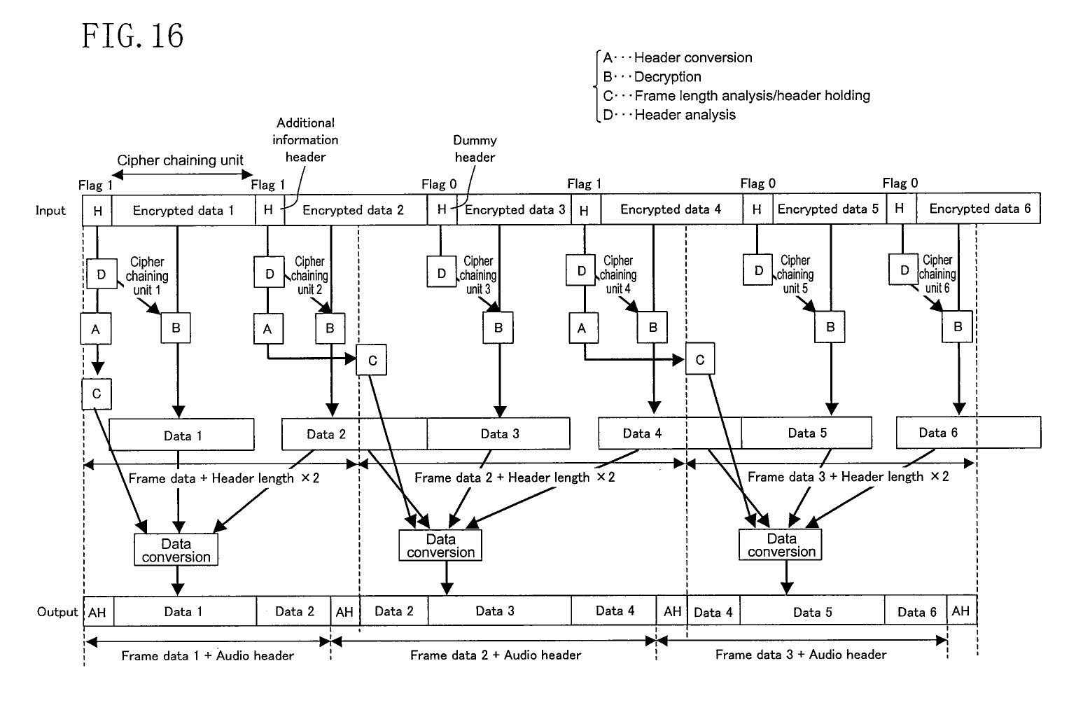

Referring to FIG. 16, the process of decrypting the encrypted content stored in the target 105 according to the present embodiment will be described conceptually. As described above, the encrypted content as reproduction object data has a data structure in which an additional information header including a frame header for the (n+1)^{th} frame data is added at the beginning of each encrypted data including therein the boundary between the n^{th} frame data and the (n+1)^{th} frame data while a dummy header including no frame header is added at the beginning of encrypted data including no frame data boundary therein. Moreover, the additional information header and the dummy header each include information on the data length of the cipher chaining unit for corresponding encrypted data.

As the header analysis/addition section 118 successively reads out encrypted content from the target 105, the header analysis/addition section 118 identifies the position of the header based on information on the data length of the cipher chaining unit stored in the header and separates the header from the encrypted data. Information on the data length of the cipher chaining unit obtained from the header is set in the encryption/decryption processing section 109. Moreover, referring to the flag of the separated header, it is determined whether the header is an additional information header including a frame header. If the header is an additional information header, the header is output to the header conversion section 115. The header conversion section 115 converts the input additional information header to an audio header (ADTS header). There may be a case where the header conversion is not necessary. The converted header is held at the frame length analysis/header holding section 116 until all of the encrypted data including frame boundaries therein are decrypted by the encryption/decryption processing section 109. Dummy headers are discarded.

On the other hand, using the information on the data length of the cipher chaining unit, the encryption/decryption processing section 109 successively decrypts the encrypted data and expands the decrypted data onto the internal memory 111. The frame length analysis/header holding section 116 detects frame boundaries based on information on the frame length stored in the additional information header, and when the decryption of encrypted data including frame boundaries therein is completed, the frame length analysis/header holding section 116 outputs the headers being held and the decrypted data, which have been expanded on the internal memory 111, to the data conversion section 117.

The data conversion section 117 performs a separation/concatenation process on the decrypted data by using the information on the frame length to thereby produce frame data. Then, the converted header is added at the beginning of the frame data, and the data is output to the decoding/audio processing section 113. The output data is data including an audio header for each frame data and being in conformity to the audio format (AAC). Therefore, the output data can be reproduced directly without needing the first CPU 102 or the system memory 103.

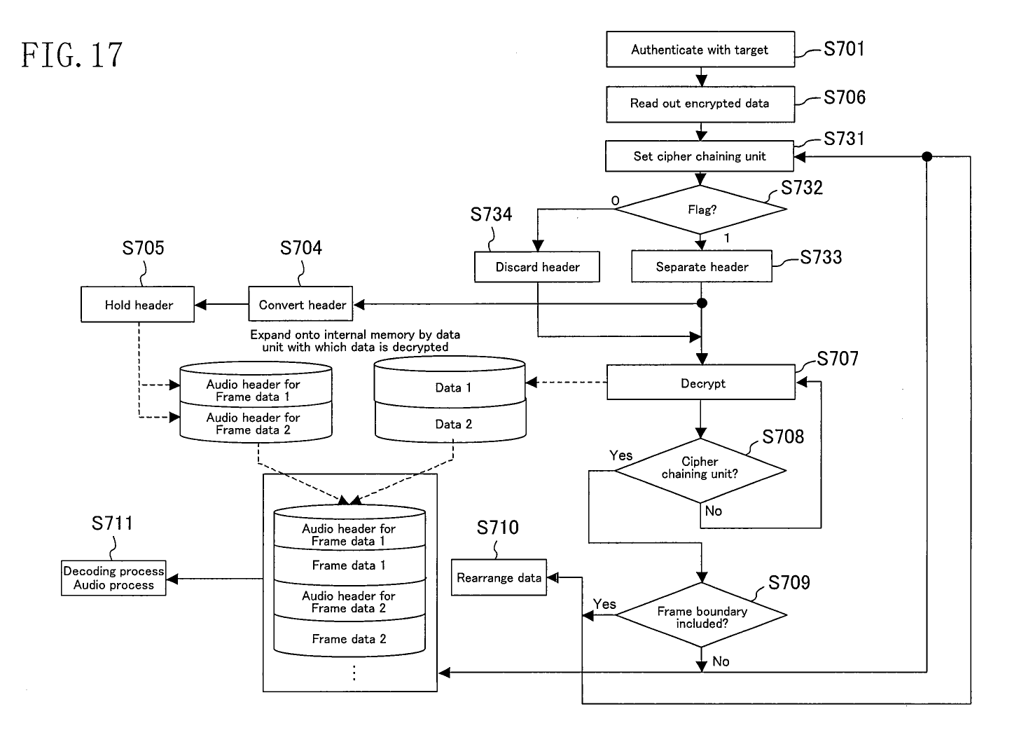

Referring to the flow chart of FIG. 17, the process of decrypting/reproducing the encrypted content as shown in FIG. 16 will be described in detail. In FIG. 17, dotted lines each represent a data process. Like steps to those of FIG. 7 in the first embodiment are denoted by like reference numerals and will not be further described below.

The header analysis/addition section 118 refers to the cipher chaining unit field of the header placed at the beginning of the encrypted data to set the data length of the cipher chaining unit in the encryption/decryption processing section 109.

The header analysis/addition section 118 determines whether the flag of the header placed at the beginning of the encrypted data is 1 or 0.

If the flag is 1, the header is an additional information header including a frame header. Therefore, the header and the encrypted data are separated from each other, and the header is output to the header conversion section 115 while the encrypted data is output to the encryption/decryption processing section 109. The encrypted data is decrypted in step S707. The header is converted in step S704.

If the flag is 0, the header is a dummy header including no frame header, and therefore the header is separated from the encrypted data and discarded. The encrypted data is output to the encryption/decryption processing section 109, and decrypted in step S707.

By decrypting the encrypted content by the method described above, it is possible to decrypt a series of encrypted data while transferring data from the internal memory 111 to the decoding/audio processing section 113 in a form where an audio header is provided at the beginning of frame data, and the decoding/audio processing section 113 can directly decode and reproduce the data. Therefore, it is possible to successively reproduce the frame data without decrypting a large amount of encrypted content as with the conventional technique, whereby the process can be performed without using the system memory at all. In addition, the header assignment is performed as a closed process within the encrypted data production/reproduction device 101, thus presenting no load on the first CPU 102. Therefore, it is possible to significantly reduce the power consumption, and it is possible to reproduce, without recharging the battery, a number of encrypted content that is a few times to ten times that with the conventional technique.

Moreover, in the present embodiment, a header is provided for every encrypted data, and the header includes information on the data length of the cipher chaining unit. Therefore, it is possible to set the cipher chaining unit by means of the header analysis/addition section 118 without the intervention from a software process by the control section 106, whereby it is possible to further reduce the power consumption.

### Fourth Embodiment

According to a fourth embodiment of the present invention, the second and third embodiments described above are combined together. Specifically, as in the third embodiment, an additional information header for the (n+1)^{th} frame data is associated with encrypted data including therein the boundary between the n^{th} frame data and the (n+1)^{th} frame data, while a dummy header including on frame header is associated with encrypted data including no frame data boundary therein. Then, as in the second embodiment, the assigned additional information headers and dummy headers are added together at the beginning of the series of a plurality of encrypted data.

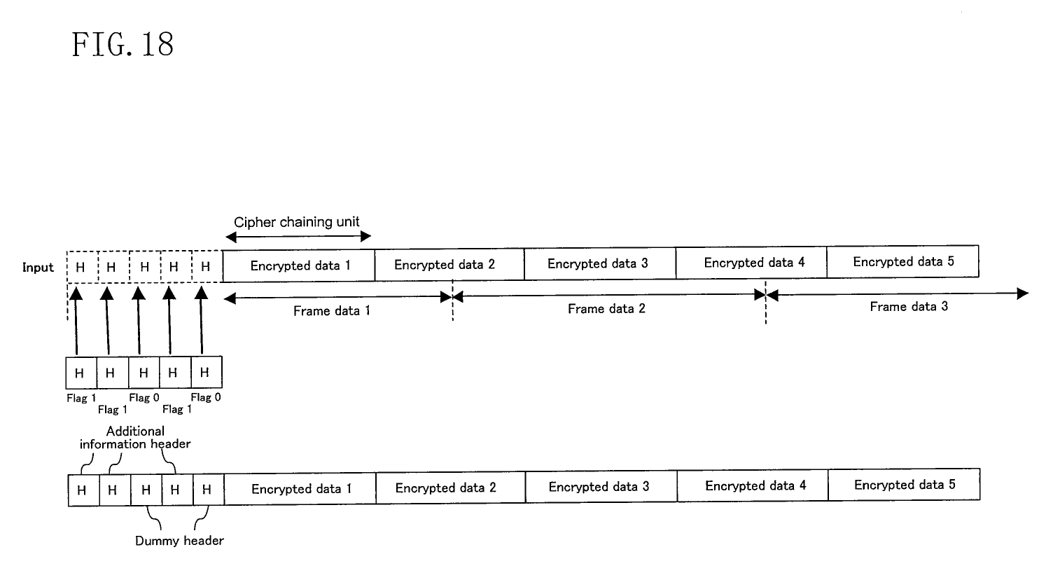

FIG. 18 shows a concept of encrypted data production according to the present embodiment. As shown in FIG. 18, additional information headers and dummy headers are placed together at the beginning of the series of encrypted data in the present embodiment.

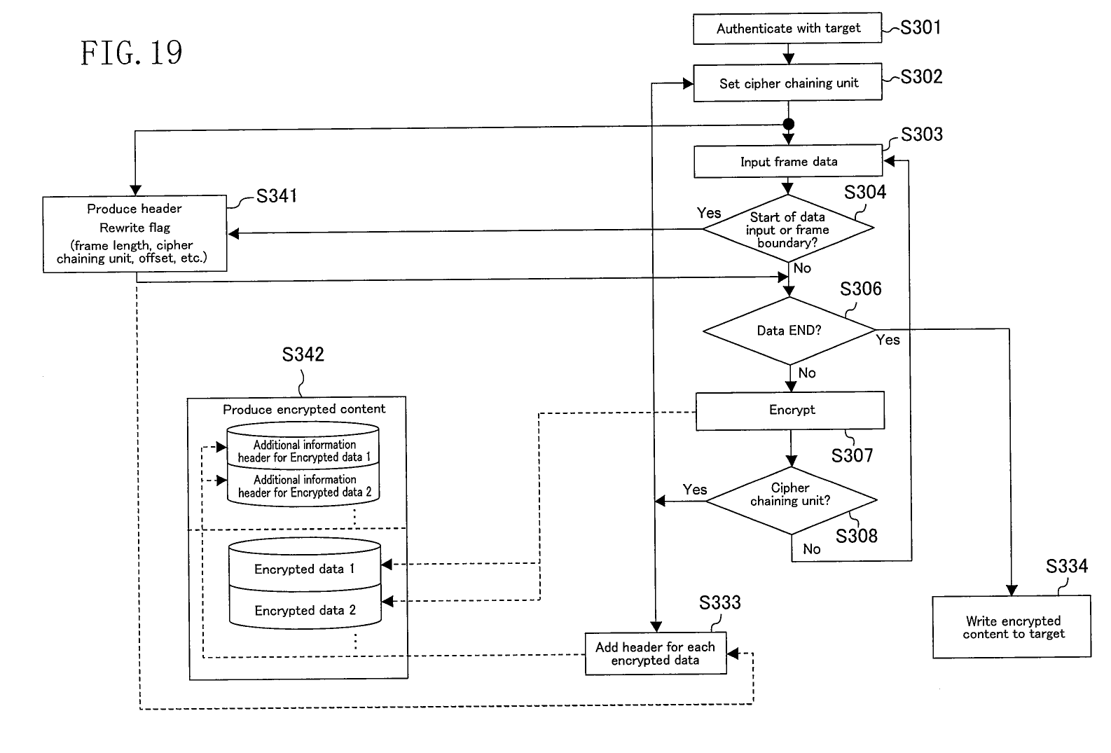

FIG. 19 is a flow chart showing a process of encrypting the AV data downloaded from outside and storing the encrypted data in the target 105, and is for producing encrypted content as shown in FIG. 18. In FIG. 19, dotted lines each represent a data process.

The flow chart of FIG. 19 is substantially similar to FIG. 15, and like steps to those of FIG. 15 are denoted by like reference numerals and will not be further described below. What is different from FIG. 15 is the header production step (S341). In step S341, the frame length/cipher chaining analysis section 114 produces additional information headers and dummy headers so that an offset is included in addition to the frame length, etc. Then, in step S333 the additional information headers and the dummy headers are placed together at the beginning of the encrypted data (S342). In such a case, it is preferred that a memory area for storing the additional information headers and the dummy headers is provided in advance when the encrypted content is produced.

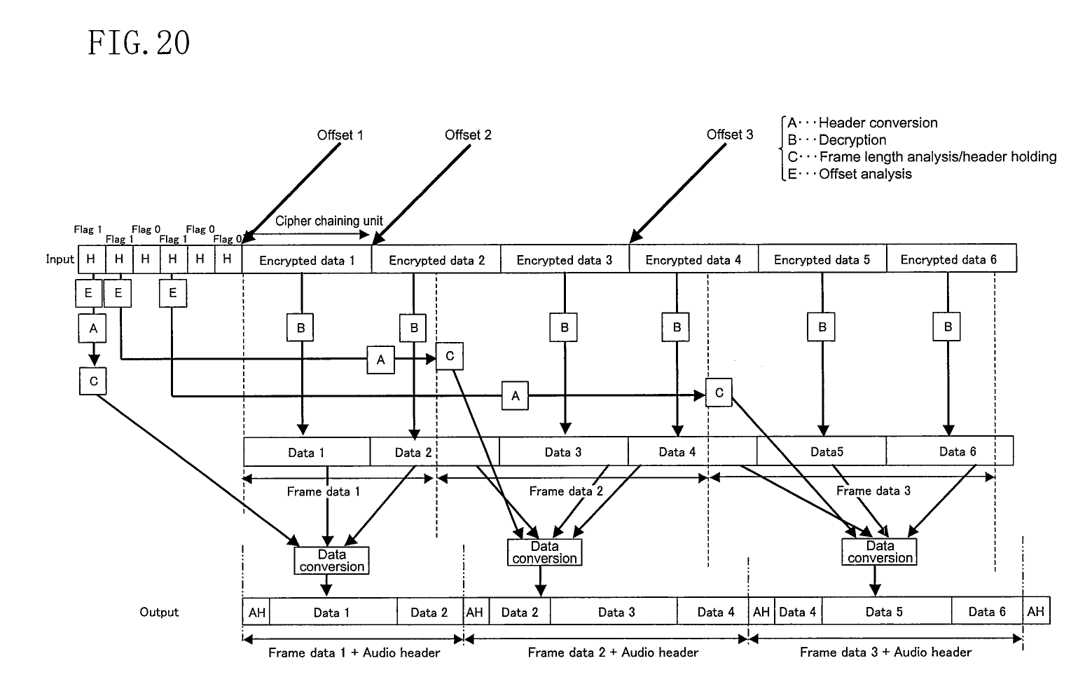

FIG. 20 conceptually shows the decryption process for decrypting the encrypted content according to the present embodiment. The process of FIG. 20 is substantially similar to the process of FIG. 16 in the third embodiment, except that the header analysis/addition section 118 determines the piece of encrypted data to which each additional information header corresponds by analyzing the offset of the additional information header.

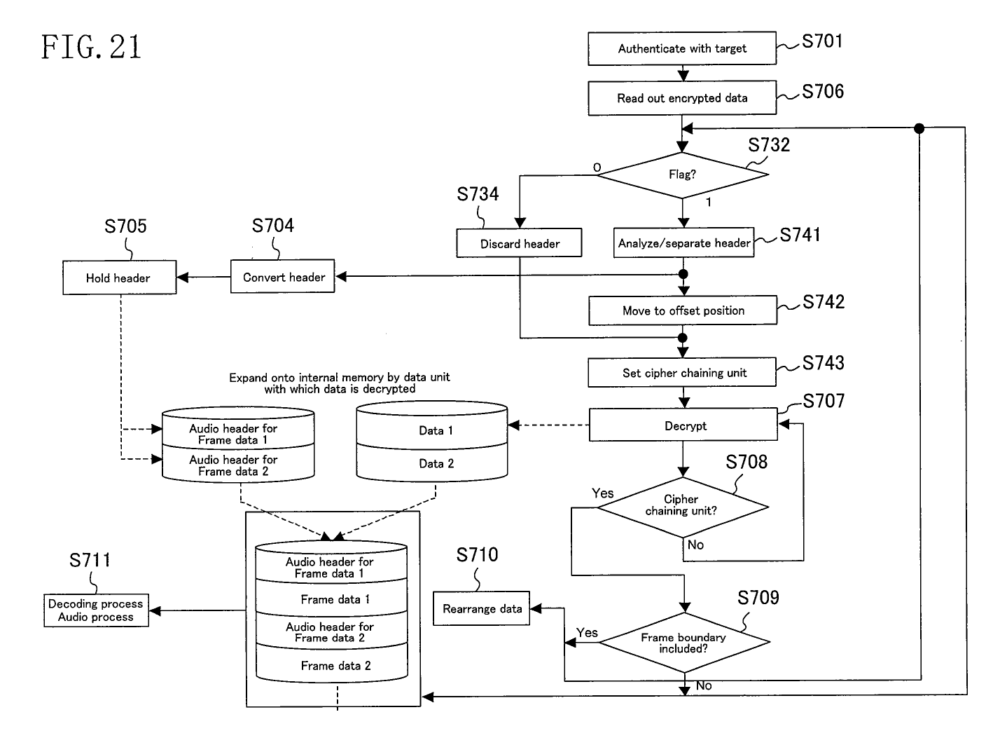

FIG. 21 is a flow chart showing the process of decrypting/reproducing the encrypted content according to the present embodiment. The flow chart of FIG. 20 is substantially similar to FIG. 17, and like steps to those of FIG. 17 are denoted by like reference numerals and will not be further described below.

If the flag is 1, the header is an additional information header including a frame header, and is therefore output to the header conversion section 115. Moreover, the offset is analyzed to determine the start position of the encrypted data to be processed.

The read address at which data is to be read out from the target 105 is changed to the beginning of the encrypted data to be processed.

The data length of the cipher chaining unit for the encrypted data to be processed is set in the encryption/decryption processing section 109.

Specifically, since the headers are added together at the beginning of a series of encrypted data in the present embodiment, the order of the header analysis/separation and the cipher chaining unit setting is reversed from that of FIG. 17. Moreover, since the header and the encrypted data are not contiguous with each other, a process of moving to the offset position is added between the header analysis/separation and the cipher chaining unit setting.

As described above, according to the present invention, it is possible to significantly reduce the power consumption, and the present invention is therefore very effective in cases such as where the encrypted data production/reproduction device 101 is configured as a portable information terminal.

### INDUSTRIAL APPLICABILITY

According to the present invention, it is possible to significantly reduce the power consumption of a device for producing/reproducing encrypted data. Therefore, the present invention is applicable to an information processing device such as a mobile phone, for example.

1. A data encryption method for encrypting encryption object data including N (N is an integer being 2 or more) pieces of frame data and management data for managing the N pieces of frame data in a cipher block chaining mode using a cipher chaining unit of an arbitrary data length, the method comprising:
a step (a) of producing, from the management data, additional information headers, each of which corresponds to one of the frame data and includes a frame header for the frame data;
a step (b) of encrypting the frame data in a cipher block chaining mode to produce a series of a plurality of encrypted data; and
a step (c) of associating one of the plurality of encrypted data that includes therein a boundary between n^{th} (n is an integer being 1 or more and less than N) frame data and (n+1)^{th} frame data with the additional information header corresponding to the (n+1)^{th} frame data, and adding the additional information header at a predetermined position in the plurality of encrypted data.

2. The data encryption method of claim 1, wherein in step (c), the additional information header is added at a beginning of the associated encrypted data.

3. The data encryption method of claim 2, wherein the additional information header includes information on the data length of the cipher chaining unit for the encrypted data existing in a range from the present additional information header to the next additional information header.

4. The data encryption method of claim 2, wherein in step (c), a dummy header including no frame header is added at a beginning of the encrypted data including no frame data boundary therein.

5. The data encryption method of claim 4, wherein the additional information header and the dummy header each include a flag indicating whether a frame header is included.

6. The data encryption method of claim 4, wherein the additional information header and the dummy header each include information on the data length of the cipher chaining unit for the encrypted data to which the header is added.

7. The data encryption method of claim 1, wherein in step (c), the additional information headers are added together at a beginning of the plurality of encrypted data.

8. The data encryption method of claim 7, wherein a dummy header including no frame header is associated with the encrypted data including no frame data boundary therein, and the dummy headers are added together at the beginning of the plurality of encrypted data along with the additional information headers.

9. The data encryption method of claim 8, wherein the additional information header and the dummy header each include a flag indicating whether a frame header is included.

10. The data encryption method of claim 1, wherein a data length of the additional information header is fixed.

11. The data encryption method of claim 1, wherein the plurality of encrypted data to which additional information headers are added and information on the data length of the cipher chaining unit are stored in external storage means.

12. An encrypted data reproduction method for reproducing reproduction object data obtained by encrypting encryption object data including N (N is an integer being 2 or more) pieces of frame data in a cipher block chaining mode using a cipher chaining unit of an arbitrary data length, wherein:
the reproduction object data includes:
a plurality of encrypted data; and
N additional information headers including N frame headers corresponding respectively to the N pieces of frame data, respectively; and
the additional information header including an (n+1)^{th} (n is an integer being 1 or more and less than N) frame header is associated with one of the plurality of encrypted data including therein a boundary between n^{th} frame data and (n+1)^{th} frame data and is added at a predetermined position of the plurality of encrypted data, the method comprising:
a step (a) of separating the additional information header from the reproduction object data;
a step (b) of decrypting the encrypted data read out from the reproduction object data by using information on the data length of the cipher chaining unit;
a step (c) of performing a separation/concatenation process on the decrypted data by using information on a frame length stored in a frame header included in the separated additional information header to thereby produce the frame data; and
a step (d) of adding the frame header at a beginning of the frame data.

13. The encrypted data reproduction method of claim 12, wherein:
the method comprises a step of converting the frame header included in the separated additional information header to a reproduction frame header; and
in step (d), the reproduction frame header is added, instead of the frame header, at the beginning of the frame data.

14. The encrypted data reproduction method of claim 12, wherein:
in the reproduction object data, the additional information header is added at a beginning of the associated encrypted data, and a dummy header including no frame header is added at a beginning of the encrypted data including no frame data boundary therein;
the additional information header and the dummy header each include a flag indicating whether a frame header is included; and
in step (a), it is determined whether a header added at a beginning of each encrypted data is the additional information header by referring to the flag.

15. The encrypted data reproduction method of claim 14, wherein:
the additional information header and the dummy header each include information on the data length of the cipher chaining unit of the encrypted data added thereto; and
in step (b), decryption of the encrypted data is performed by using the information on the data length of the cipher chaining unit included in the additional information header or the dummy header added to the encrypted data.

16. The encrypted data reproduction method of claim 12, wherein:
the reproduction object data and information on the data length of the cipher chaining unit are read out from external storage means; and
in step (b), decryption of the encrypted data is performed by using the information on the data length of the cipher chaining unit read out from the external storage means.

17. An encrypted data production device for encrypting encryption object data including N (N is an integer being 2 or more) pieces of frame data and management data for managing the N pieces of frame data, in a cipher block chaining mode using a cipher chaining unit of an arbitrary data length, the device comprising:
a header production section for producing, from the management data, additional information headers, each of which corresponds to one of the frame data and includes a frame header for the frame data; and
a cipher processing section for encrypting the frame data in a cipher block chaining mode to produce a series of a plurality of encrypted data; and
a header addition section for associating one of the plurality of encrypted data that includes therein a boundary between n^{th} (n is an integer being 1 or more and less than N) frame data and (n+1)^{th} frame data with the additional information header corresponding to the (n+1)^{th} frame data, and adding the additional information header at a predetermined position in the plurality of encrypted data.

18. The encrypted data production device of claim 17, wherein the header addition section adds the additional information header at a beginning of the associated encrypted data.

19. The encrypted data production device of claim 18, wherein the header addition section adds a dummy header including no frame header at a beginning of the encrypted data including no frame data boundary therein.

20. The encrypted data production device of claim 17, wherein the header addition section adds the additional information headers together at a beginning of the plurality of encrypted data.

21. The encrypted data production device of claim 20, wherein the header addition section associates a dummy header including no frame header with the encrypted data including no frame data boundary therein, and adds the dummy headers together at the beginning of the plurality of encrypted data along with the additional information headers.

22. An encrypted data reproduction device for reproducing reproduction object data obtained by encrypting encryption object data including N (N is an integer being 2 or more) pieces of frame data in a cipher block chaining mode using a cipher chaining unit of an arbitrary data length, wherein:
the reproduction object data includes:
a plurality of encrypted data; and
N additional information headers including N frame headers corresponding respectively to the N pieces of frame data, respectively; and
the additional information header including an (n+1)^{th} (n is an integer being 1 or more and less than N) frame header is associated with one of the plurality of encrypted data including therein a boundary between n^{th} frame data and (n+1)^{th} frame data and is added at a predetermined position of the plurality of encrypted data, the device comprising:
a header separation section for separating the additional information header from the reproduction object data;
a decryption processing section for decrypting the encrypted data read out from the reproduction object data by using information on the data length of the cipher chaining unit;
a frame data production section for performing a separation/concatenation process on the decrypted data by using information on a frame length stored in a frame header included in the separated additional information header to thereby produce the frame data; and
a header addition section for adding the frame header at the beginning of the frame data.

23. The encrypted data reproduction device of claim 22, wherein:
the device comprises a header conversion section for converting the frame header included in the separated additional information header to a reproduction frame header; and
the header addition section adds the reproduction frame header obtained by the header conversion section, instead of the frame header, at the beginning of the frame data.

24. The encrypted data reproduction device of claim 22, wherein:
in the reproduction object data, the additional information header is added at a beginning of the associated encrypted data, and a dummy header including no frame header is added at a beginning of the encrypted data including no frame data boundary therein;
the additional information header and the dummy header each include a flag indicating whether a frame header is included; and
the header separation section determines whether a header added at a beginning of each encrypted data is the additional information header by referring to the flag.

25. The encrypted data reproduction device of claim 24, wherein:
the additional information header and the dummy header each include information on the data length of the cipher chaining unit of the encrypted data added thereto; and
the decryption processing section decrypts encrypted data by using the information on the data length of the cipher chaining unit included in the additional information header or the dummy header added to the encrypted data.

26. The encrypted data reproduction device of claim 22, wherein:
the reproduction object data and information on the data length of the cipher chaining unit are read out from external storage means; and
the decryption processing section decrypts the encrypted data by using the information on the data length of the cipher chaining unit read out from the external storage means.

27. A data structure, in which encryption object data including N (N is an integer being 2 or more) pieces of frame data is encrypted in a cipher block chaining mode using a cipher chaining unit of an arbitrary data length, the data structure comprising:
a plurality of encrypted data; and
N additional information headers including N frame headers corresponding respectively to the N pieces of frame data, respectively;
the additional information header including an (n+1)^{th} (n is an integer being 1 or more and less than N) frame header is associated with one of the plurality of encrypted data including therein a boundary between n^{th} frame data and (n+1)^{th} frame data and is added at a predetermined position of the plurality of encrypted data.

28. The data structure of claim 27, wherein the additional information header is added at a beginning of the associated encrypted data.

29. The data structure of claim 28, wherein a dummy header including no frame header is added at a beginning of the encrypted data including no frame data boundary therein.

30. The data structure of claim 29, wherein the additional information header and the dummy header each include a flag indicating whether a frame header is included.

31. The data structure of claim 27, wherein the additional information headers are added together at a beginning of the plurality of encrypted data.

32. The data structure of claim 31, wherein dummy headers including no frame header and associated with the encrypted data including no frame data boundary therein are added together at the beginning of the plurality of encrypted data along with the additional information headers.
